(19) United States
(12) Patent Application Publication
(10) Pub. No.: US 2020/0222281 A1
(43) Pub. Date: Jul. 16, 2020

(54) Sterile Product Bag with Filtered Port

(71) Applicants: BAXTER INTERNATIONAL INC., Deerfield, IL (US); BAXTER HEALTHCARE SA, Glattpark ( Opfikon) (CH)

(72) Inventors: Yuanpang Samuel Ding, Long Grove, IL (US); Ying-Cheng Lo, Long Grove, IL (US); Mark Joseph Doty, Grayslake, IL (US); David Filiberto Schuck, Long Grove, IL (US); Karl Hans Cazzini, Lindenhurst, IL (US); Grant Anthony Bomgaars, Kildeer, IL (US); Bernd Krause, Rangendingen (DE); Thomas Edward Dudar, Palatine, IL (US); Mark Edward Pasmore, Grayslake, IL (US); Michael Joseph Sadowski, Ringwood, IL (US); Anastasios Hristakos, Evanston, IL (US); Joseph Vincent Ranalletta, Greenville, SC (US)

(21) Appl. No.: 16/630,983

(22) PCT Filed: Jul. 12, 2018
(86) PCT No.: PCT/US18/41800

§ 371 Date: Jan. 14, 2020

Related U.S. Application Data
(60) Provisional application No. 62/533,362, filed on Jul. 17, 2017.

(51) Int. Cl. A61J 1/14; A61J 1/10; A61J 1/20

(52) U.S. Cl. CPC A61J 1/1456; A61J 1/10; A61J 1/1475; A61J 1/2048; A61J 1/201; A61J 1/2089; A61J 2200/70; A61J 1/2027; A61J 1/2024

(57) ABSTRACT

A sterile product bag includes a bladder, a stem, a filter, and a vial adaptor. The bladder has a perimeter seal and defining a sterile chamber. The stem extends through the perimeter seal and has an inlet end outside of the perimeter seal and an outlet end in fluid communication with the chamber. The filter is disposed in line with the stem and has a filter membrane with a nominal pore size in a range of approximately 0.1 μm to approximately 0.5 μm. The filter membrane is shaped as a hollow fiber with a wall and pores residing in the wall of the fiber. The vial adaptor includes a sterile hollow cannula, a sheath, and a peelable closure. The cannula is in fluid communication with the chamber of the bladder. The sheath is disposed outside of the bladder and connected to the hollow cannula. The sheath includes an interior cavity into which the hollow cannula extends. The peelable closure extends across an opening of the sheath to seal the interior cavity.

### CROSS-REFERENCE TO AND RELATED APPLICATIONS

Priority is claimed to U.S. Provisional Application Ser. No. 62/533,362, filed Jul. 17, 2017, the entire contents of which are incorporated herein by reference.

Additionally, the following related and co-owned U.S. or applications are hereby expressly incorporated herein by reference in their entirety: U.S. Provisional Application Ser. No. 62/533,380, having Attorney Docket No.: 31203/52019P (entitled DUAL CONTAINER SYSTEM FOR PRODUCT RECONSTITUTION); U.S. Provisional Application Ser. No. 62/533,408, having Attorney Docket No.: 31203/52032P (entitled MEDICAL PRODUCT INCLUDING PRE-FILLED PRODUCT BAG WITH FILTERED FLUID PORT); U.S. Provisional Application Ser. No. 62/533,427, having Attorney Docket No.: 31203/52050P (entitled FILTERED PRODUCT BAG WITH COMPACT FORM FACTOR); and U.S. Provisional Application Ser. No. 62/533,440, having Attorney Docket No.: 31203/52062P (entitled MEDICAL SYRINGE SYSTEM WITH FILTERED FILLING PORT), each filed on Jul. 17, 2017.

### FIELD OF THE DISCLOSURE

This disclosure relates to a sterile product bag and, in particular, a sterile product bag having an integral filter that allows microbial and particulate matter filtration during filling in non-traditional settings for the purposes of concentrate reconstitution.

### BACKGROUND

Often, drugs and nutrients are mixed with a diluent before being delivered to a patient. The diluent may be, for example, a dextrose solution, a saline solution or even water. Many such drugs or nutrients are supplied in a concentrated form such as powder, liquid, gel, foam, etc., and packaged in glass or plastic vials.

In order for the concentrate to be administered to a patient, it must first undergo reconstitution. As used herein, the term reconstitution includes not only liquidization of non-liquid concentrates but also dilution of liquid concentrates.

One way of reconstituting a concentrate is first to inject a diluent into the vial holding the concentrate. This may typically be performed by a syringe having a liquid diluent contained in the syringe barrel. After the rubber stopper of the vial is pierced by the syringe needle, the liquid is injected into the vial. The vial is shaken to reconstitute and dilute the concentrate with the liquid. The liquid is then withdrawn back into the syringe. After the mixing, the syringe is withdrawn and the reconstituted product may then be injected into a medication port of a pre-filled parenteral solution container (e.g., an IV bag) containing a medical solution or diluent such as dextrose or saline solution. The drug, now diluted with the medical solution in the parenteral solution container, is delivered through an administration set for intravenous administration to the patient. These pre-filled solution containers are provided to the health care provider in sterile form.

Some known parenteral solution containers have even been developed to include a device for connecting directly to the vial, thereby bypassing the need for the syringe to transfer the concentrate to the diluent within the container. Such devices utilize a vial attachment assembly attached to a port of the solution container. The attachment assembly includes a cannula with a sharp exterior end sealed inside of a sheath with a removable closure or extending within a housing having an opening covered by a foil or other membrane closure. These sheaths or closures maintain sterility of the fluid transfer path during storage. When reconstitution is required, the removable closure can be removed and a vial containing concentrate is pierced with the sharp end of the cannula to provide for fluid communication back and forth between the vial and the interior chamber of the parenteral container. This allows the user to mix the concentrate and diluent and place the solution in the parenteral container for administration to the patient.

Another assembly for mixing drug concentrate, whether lyophilized or liquid, with diluent is generally referred to as a dual chamber container. In such an assembly the container is formed with two or more chambers separated by a seal that may be ruptured by the user during reconstitution. For example a lyophilized powder may be provided in one of the chambers and a diluent provided in the other. Shortly before administration, the user squeezes the container causing a separating seal to rupture so that the two chambers are placed in fluid communication and the contents are mixed. The resulting solution is then administered to the patient.

Whether the diluent is provided in a parenteral solution container to which the reconstituted drug is added by injection through a port or by directly attaching a vial to the container, the fluid contents and all surfaces coming into contact with the solution must be provided in a sterile condition. If possible, sterilization is provided by heat such as by a steam sterilization process. The high temperatures to which the containers are exposed during the sterilization cycle may limit the materials from which the containers may be formed. For containers having a vial attachment assembly which is also to be sterilized, the design of the vial attachment assembly must be such that the sterilizing steam can penetrate into all portions that will come into contact with the fluid, either during storage or reconstitution.

For dual chamber containers, the method to provide a container with a sterile interior and contents may be even more difficult. Frequently the concentrate cannot withstand the temperatures during a steam sterilization process. So the chambers must be filled within a highly sterile or aseptic environment, such as within an isolator. One method of filling is to provide the container with sacrificial port tubes in communication with each chamber for adding the component to such chamber. After the addition, the port tubes are sealed and cuttingly removed from the container. Such a process adds costs to the production of the container.

By providing any of the above described containers with a stored diluent, the volume and weight of the container is increased by this diluent. This directly impacts transportation and storage costs. Moreover, the inclusion of the liquid diluent may cause the container to have a defined shelf life that must be monitored so that the container is used prior to the expiration of the labelled shelf life.

### SUMMARY

One aspect of the present disclosure is directed to a sterile product bag that includes a bladder, a stem, a filter, and a port to provide access to the interior of the container such as including a vial adaptor and/or a Luer-Activated-Device (LAD). The bladder has a perimeter seal and defining a sterile chamber. The stem extends through the perimeter seal and has an inlet end outside of the perimeter seal and an outlet end in fluid communication with the chamber. The filter is disposed in line with the stem and has a filter membrane with a nominal pore size in a range of approximately 0.1 μm to approximately 0.5 μm. The filter membrane is shaped as a hollow fiber with a wall and pores residing in the wall of the fiber. The port such as a vial adaptor or LAD is in selective fluid communication with the sterile chamber.

In some aspects, the vial adaptor includes a sterile hollow cannula, a sheath, and a peelable closure. The cannula is in fluid communication with the chamber of the bladder. The sheath is disposed outside of the bladder and connected to the hollow cannula. The sheath includes an interior cavity into which the hollow cannula extends. The peelable closure extends across an opening of the sheath to seal the interior cavity.

In some aspects, the filter membrane is disposed inside of the stem between the inlet and outlet ends.

In some aspects, the filter comprises a plurality of filter membranes

In some aspects, the outlet end of the hollow fiber of the filter membrane is sealed and the inlet end is an open inlet.

In some aspects, the filter membrane has a wall thickness in the range of approximately 150 μm to approximately 500 μm.

In some aspects, the filter membrane has a longitudinal dimension in the range of approximately 3 cm to approximately 420 cm, an inner diameter in the range of approximately 2 mm to approximately 4 mm, and an outer diameter in the range of approximately 2.3 mm to approximately 5 mm.

In some aspects, the filter membrane is made of at least one of the following materials: a polyolefin, polyvinylidene fluoride, polymethylmethacrylate, polyacrylonitrile, polysulfone, polyethersulfone, and a polymer containing cationic charges.

In some aspects, the stem is one of a flexible stem or a rigid stem.

In some aspects, the stem is made of at least one of the following materials: PVC, PET, a poly(meth)acrylate, a polycarbonate, a polyolefin, a cycloolefin copolymer, polystyrene, or a silicone polymer.

In some aspects, the filter includes at least one U-shaped hollow fiber filter membrane secured in a U-shaped configuration by a filter membrane housing contained within a filter body.

In some aspects, the filter includes a plurality of U-shaped hollow fiber filter membranes.

In some aspects, the filter comprises a plurality of parallel hollow fiber membrane filters secured in a side-by-side configuration.

In some aspects, the filter comprises a plurality of parallel hollow fiber membrane filters arranged in a circular pattern.

In some aspects, the filter membrane has a nominal pore size in a range of approximately 0.1 μm to approximately 0.22 μm.

In some aspects, the product bag further includes a breakaway valve disposed in the hollow cannula of the vial adaptor.

In some aspects, the sterile chamber is empty until a diluent is introduced to the chamber through the filter.

In some aspects, the chamber comprises at least a first chamber portion in fluid communication with the stem, and a second chamber portion isolated from the first chamber portion by an intermediate seal.

In some aspects, the first chamber portion of the chamber is empty until a diluent is introduced to the first chamber portion through the filter.

In some aspects, the bladder comprises adjacent front and rear films secured together by the perimeter seal, and the intermediate seal comprises a peelable seal formed by a bond between adjacent interior surface portions of the front and rear films, the peelable seal adapted to be broken to facilitate fluid communication between the first and second chamber portions.

In some aspects, the second chamber portion is not in fluid communication with the stem until the intermediate seal is broken.

In some aspects, the product bag further includes a medicinal or nutritional concentrate disposed in the second chamber portion.

In some aspects, the medicinal or nutritional concentrate is a sterile concentrate.

Another aspect of the disclosure is directed to a sterile product bag including a bladder, a peelable seal, a stem, and a filter. The bladder includes adjacent front and rear films secured together by a perimeter seal and defining a sterile chamber comprising at least a first chamber portion and a second chamber portion isolated from the first chamber portion by a peelable seal formed by a bond between adjacent interior surface portions of the front and rear films. The peelable seal is adapted to be broken to facilitate fluid communication between the first and second chamber portions. The stem extends through the perimeter seal and has an inlet end outside of the perimeter seal and an outlet end in fluid communication with the first chamber portion. The filter is disposed in line with the stem and has a filter membrane with a nominal pore size in a range of approximately 0.1 μm to approximately 0.5 μm. The filter membrane is shaped as a hollow fiber with a wall and pores residing in the wall of the fiber.

In some aspects, the filter membrane is disposed inside of the stem between the inlet and outlet ends.

In some aspects, the filter comprises a plurality of filter membranes.

In some aspects, the outlet end of the hollow fiber of the filter membrane is sealed and the inlet end is an open inlet.

In some aspects, the filter membrane has a wall thickness in the range of approximately 150 μm to approximately 500 μm.

In some aspects, the filter membrane has a longitudinal dimension in the range of approximately 3 cm to approximately 420 cm, an inner diameter in the range of approximately 2 mm to approximately 4 mm, and an outer diameter in the range of approximately 2.3 mm to approximately 5 mm.

In some aspects, the filter membrane is made of at least one of the following materials: a polyolefin, polyvinylidene fluoride, polymethylmethacrylate, polyacrylonitrile, polysulfone, polyethersulfone, and a polymer containing cationic charges.

In some aspects, the stem is one of a flexible stem or a rigid stem.

In some aspects, the stem is made of at least one of the following materials: PVC, PET, a poly(meth)acrylate, a polycarbonate, a polyolefin, a cycloolefin copolymer, polystyrene, or a silicone polymer.

In some aspects, the filter includes at least one U-shaped hollow fiber filter membrane secured in a U-shaped configuration by a filter membrane housing contained within a filter body.

In some aspects, the filter includes a plurality of U-shaped hollow fiber filter membranes.

In some aspects, the filter comprises a plurality of parallel hollow fiber membrane filters secured in a side-by-side configuration.

In some aspects, the filter comprises a plurality of parallel hollow fiber membrane filters arranged in a circular pattern.

In some aspects, the filter membrane has a nominal pore size in a range of approximately 0.1 μm to approximately 0.22 μm.

In some aspects, the product bag further includes a vial adaptor and/or a Luer-Activated-Device (LAD).

In some aspects, the vial adaptor includes a sterile hollow cannula in fluid communication with the second chamber portion of the bladder, a sheath disposed outside of the bladder and connected to the hollow cannula, the sheath comprising an interior cavity into which the hollow cannula extends, the peelable closure extending across an opening of the sheath to seal the interior cavity.

In some aspects, the product bag further includes a breakaway valve disposed in the hollow cannula of the vial adaptor.

In some aspects, the product bag further includes a medicinal or nutritional concentrate disposed in the second chamber portion.

In some aspects, the medicinal or nutritional concentrate is a sterile concentrate.

In some aspects, the first chamber portion is empty until a diluent is introduced into the first chamber portion through the filter.

Yet another aspect of the present disclosure is directed to a method of reconstituting a medicinal or nutritional substance. The method includes providing a bladder having a perimeter seal and defining a sterile chamber, a stem extending through the perimeter seal and having an inlet end outside of the perimeter seal and an outlet end in fluid communication with the chamber, a filter disposed in line with the stem, the filter having a filter membrane with a nominal pore size in a range of approximately 0.1 μm to approximately 0.5 μm, wherein the filter membrane is shaped as a hollow fiber with a wall and pores residing in the wall of the fiber. The method also includes introducing a diluent into the chamber of the bladder through the filter membrane such that a sterile diluent resides within the chamber. The method also includes introducing a sterile medicinal or nutritional concentrate into the chamber of the bladder. The method also includes mixing the diluent and the concentrate in the chamber of the bladder to reconstitute the substance.

In some aspects, introducing the diluent into the chamber of the bladder through the filter membrane comprises introducing the diluent through a plurality of filter membranes.

In some aspects, introducing the diluent into the chamber of the bladder through the filter membrane comprises introducing the diluent through an open outlet end and a sealed outlet end of the hollow fiber of the filter membrane.

In some aspects, introducing the diluent into the chamber of the bladder through the filter membrane comprises introducing the diluent through a filter membrane having a wall thickness in the range of approximately 150 μm to approximately 500 μm.

In some aspects, introducing the diluent into the chamber of the bladder through the filter membrane comprises introducing the diluent through a filter membrane having a longitudinal dimension in the range of approximately 3 cm to approximately 420 cm, an inner diameter in the range of approximately 2 mm to approximately 4 mm, and an outer diameter in the range of approximately 2.3 mm to approximately 5 mm.

In some aspects, introducing the diluent into the chamber of the bladder through the filter membrane comprises introducing the diluent through a filter membrane made of at least one of the following materials: a polyolefin, polyvinylidene fluoride, polymethylmethacrylate, polyacrylonitrile, polysulfone, polyethersulfone, and a polymer containing cationic charges.

In some aspects, introducing the diluent into the chamber of the bladder through the filter membrane comprises introducing the diluent through a filter having at least one U-shaped hollow fiber filter membrane secured in a U-shaped configuration by a filter membrane housing contained within a filter body.

In some aspects, introducing the diluent through a filter having at least one U-shaped hollow fiber filter membrane comprises introducing diluent through a plurality of U-shaped hollow fiber filter membranes.

In some aspects, introducing the diluent into the chamber of the bladder through the filter membrane comprises introducing the diluent through a plurality of parallel hollow fiber membrane filters secured in a side-by-side configuration.

In some aspects, introducing the diluent into the chamber of the bladder through the filter membrane comprises introducing the diluent through a plurality of parallel hollow fiber membrane filters arranged in a circular pattern.

In some aspects, introducing the diluent into the chamber of the bladder through the filter membrane comprises introducing the diluent through a filter membrane having a nominal pore size in a range of approximately 0.1 μm to approximately 0.22 μm.

In some aspects, thee method further includes providing a vial adaptor including a sterile hollow cannula in fluid communication with the chamber of the bladder, a sheath disposed outside of the bladder and connected to the hollow cannula, the sheath comprising an interior cavity into which the hollow cannula extends, the peelable closure extending across an opening of the sheath to seal the interior cavity.

In some aspects the method further includes providing a vial containing the medicinal or nutritional concentrate and piercing a septum of the vial with the hollow cannula of the vial adaptor prior to introducing the concentrate to the chamber of the bladder.

In some aspects, the method further includes introducing a portion of the sterile diluent from the chamber of the bladder into the vial prior to introducing the concentrate to the chamber of the bladder.

In some aspects, the method further includes breaking a breakaway valve disposed in the hollow cannula of the vial adaptor prior to introducing the concentrate into the chamber of the bladder.

In some aspects, the method further includes removing the peelable closure from the vial adaptor before introducing the concentrate to the chamber of the bladder.

In some aspects, the method further includes providing the sterile chamber with at least a first chamber portion in fluid communication with the stem, and a second chamber portion isolated from the first chamber portion by an intermediate seal, wherein introducing a diluent into the chamber of the bladder comprises introducing the diluent into the first chamber portion.

In some aspects, the method further includes providing the concentrate in the second chamber portion wherein introducing the concentrate to the chamber comprises breaking the intermediate seal and introducing the concentrate to the first chamber portion.

In some aspects, the method further includes sealing and cutting the stem at a location between the filter and the bladder after introducing the diluent through the filter.

In some aspects, the method further includes performing a filter integrity test on the filter after cutting the stem and filter off of the product bag.

In some aspects, performing the filter integrity test comprises one of a pressure degradation test, a bubble point test, a water intrusion test, or a water flow test.

Still another aspect of the present disclosure includes a method of preparing doses for patient delivery. The method includes providing a bladder having a perimeter seal and defining a sterile chamber, a stem extending through the perimeter seal and having an inlet end outside of the perimeter seal and an outlet end in fluid communication with the chamber, a filter disposed in line with the stem, the filter having a filter membrane with a nominal pore size in a range of approximately 0.1 μm to approximately 0.5 μm, wherein the filter membrane is shaped as a hollow fiber with a wall and pores residing in the wall of the fiber. The method also includes introducing at least one medical fluid into the sterile chamber of the bladder through the filter membrane such that a sterile medical solution resides within the sterile chamber. The method also includes withdrawing a plurality of distinct and separate doses of the at least one sterile medical solution from the chamber through a Luer-Activated-Device (LAD) that is selectively fluidly coupled to the sterile chamber.

In some aspects, introducing the at least one sterile medical fluid into the sterile chamber comprises introducing a sterile medicinal or nutritional concentrate and a sterile diluent into the sterile chamber, and mixing the diluent and the concentrate in the chamber to reconstitute a patient-deliverable substance.

In some aspects, introducing the at least one sterile medical fluid into the sterile chamber through the filter membrane comprises introducing the fluid through a plurality of filter membranes.

In some aspects, introducing the at least one sterile medical fluid into the sterile chamber through the filter membrane comprises introducing the at least one medical fluid through an open inlet end and a sealed outlet end of the hollow fiber of the filter membrane.

In some aspects, introducing the at least one sterile medical fluid into the sterile chamber through the filter membrane comprises introducing the at least one medical fluid through a filter membrane having a wall thickness in the range of approximately 150 μm to approximately 500 μm.

In some aspects, introducing the at least one sterile medical fluid into the sterile chamber through the filter membrane comprises introducing the at least one medical fluid through a filter membrane having a longitudinal dimension in the range of approximately 3 cm to approximately 420 cm, an inner diameter in the range of approximately 2 mm to approximately 4 mm, and an outer diameter in the range of approximately 2.3 mm to approximately 5 mm.

In some aspects, introducing the at least one sterile medical fluid into the sterile chamber through the filter membrane comprises introducing the at least one medical fluid through a filter membrane made of at least one of the following materials: a polyolefin, polyvinylidene fluoride, polymethylmethacrylate, polyacrylonitrile, polysulfone, polyethersulfone, and a polymer containing cationic charges.

In some aspects, introducing the at least one sterile medical fluid into the sterile chamber through the filter membrane comprises introducing the at least one medical fluid through a filter having at least one U-shaped hollow fiber filter membrane secured in a U-shaped configuration by a filter membrane housing contained within a filter body.

In some aspects, introducing the at least one medical fluid through a filter having at least one U-shaped hollow fiber filter membrane comprises introducing medical fluid through a plurality of U-shaped hollow fiber filter membranes.

In some aspects, introducing the at least one sterile medical fluid into the sterile chamber through the filter membrane comprises introducing the at least one medical fluid through a plurality of parallel hollow fiber membrane filters secured in a side-by-side configuration.

In some aspects, introducing the at least one sterile medical fluid into the sterile chamber through the filter membrane comprises introducing the at least one medical fluid through a plurality of parallel hollow fiber membrane filters arranged in a circular pattern.

In some aspects, introducing the at least one sterile medical fluid into the sterile chamber through the filter membrane comprises introducing the at least one medical fluid through a filter membrane having a nominal pore size in a range of approximately 0.1 μm to approximately 0.22 μm.

In some aspects, the method further includes providing a vial adaptor including a sterile hollow cannula in fluid communication with the chamber of the bladder, a sheath disposed outside of the bladder and connected to the hollow cannula, the sheath comprising an interior cavity into which the hollow cannula extends, the peelable closure extending across an opening of the sheath to seal the interior cavity.

In some aspects, providing a vial containing the medicinal or nutritional concentrate and piercing a septum of the vial with the hollow cannula of the vial adaptor prior to introducing the concentrate to the chamber of the bladder.

In some aspects, the method further includes introducing a portion of the sterile diluent from the chamber of the bladder into the vial prior to introducing the concentrate to the chamber of the bladder.

In some aspects, the method further includes breaking a breakaway valve disposed in the hollow cannula of the vial adaptor prior to introducing the concentrate into the chamber of the bladder.

In some aspects, the method further includes removing the peelable closure from the vial adaptor before introducing the concentrate to the chamber of the bladder.

In some aspects, the method further includes providing the sterile chamber with at least a first chamber portion in fluid communication with the stem, and a second chamber portion isolated from the first chamber portion by an intermediate seal, wherein introducing a diluent into the chamber of the bladder comprises introducing the diluent into the first chamber portion.

In some aspects, providing a concentrate in the second chamber portion and introducing the concentrate to the chamber by breaking the intermediate seal and introducing the concentrate to the first chamber portion.

In some aspects, the method further includes sealing and cutting the stem at a location between the filter and the bladder after introducing the diluent through the filter.

In some aspects, the method further includes performing a filter integrity test on the filter after cutting the stem and filter off of the product bag.

In some aspects, performing the filter integrity test comprises one of a pressure degradation test, a bubble point test, a water intrusion test, or a water flow test.

A still yet further aspect of the present disclosure includes an ambulatory pump for dispensing a liquid under pressure. The ambulatory pump includes a housing, a product bag, a stem, and a filter. The product bag includes a pressurizable and expandable bladder defining an interior storage volume. The bladder is carried by the housing for receiving and dispensing the liquid, and is expandable between an unexpanded condition and an expanded condition. The stem has an inlet end and an outlet end, the outlet end in fluid communication with the interior of the bladder. The filter is disposed in line with the stem and has a filter membrane with a nominal pore size in a range of approximately 0.1 μm to approximately 0.5 μm, wherein the filter membrane is shaped as a hollow fiber with a wall and pores residing in the wall of the fiber.

In some aspects, the filter membrane is disposed inside of the stem between the inlet and outlet ends.

In some aspects, the filter comprises a plurality of filter membranes.

In some aspects, the hollow fiber of the filter membrane has a sealed outlet end and an open inlet end.

In some aspects, the filter membrane has a wall thickness in the range of approximately 150 μm to approximately 500 μm.

In some aspects, the filter membrane has a longitudinal dimension in the range of approximately 3 cm to approximately 420 cm, an inner diameter in the range of approximately 2 mm to approximately 4 mm, and an outer diameter in the range of approximately 2.3 mm to approximately 5 mm.

In some aspects, the filter membrane is made of at least one of the following materials: a polyolefin, polyvinylidene fluoride, polymethylmethacrylate, polyacrylonitrile, polysulfone, polyethersulfone, and a polymer containing cationic charges.

In some aspects, the stem is one of a flexible stem or a rigid stem.

In some aspects, the stem is made of at least one of the following materials: PVC, PET, a poly(meth)acrylate, a polycarbonate, a polyolefin, a cycloolefin copolymer, polystyrene, or a silicone polymer.

In some aspects, the filter includes at least one U-shaped hollow fiber filter membrane secured in a U-shaped configuration by a filter membrane housing contained within a filter body.

In some aspects, the filter includes a plurality of U-shaped hollow fiber filter membranes.

In some aspects, the filter comprises a plurality of parallel hollow fiber membrane filters secured in a side-by-side configuration.

In some aspects, the filter comprises a plurality of parallel hollow fiber membrane filters arranged in a circular pattern.

In some aspects, the filter membrane has a nominal pore size in a range of approximately 0.1 μm to approximately 0.22 μm.

### BRIEF DESCRIPTION OF THE DRAWINGS

While the specification concludes with claims particularly pointing out and distinctly claiming the subject matter that is regarded as the present disclosure, it is believed that the disclosure will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings are necessarily to scale.

FIG. 1 is a front view of a sterile product bag having a flat sheet membrane filter disposed in-line with a stem of the product bag in accordance with the teachings of the present disclosure;

FIG. 2 is a right side view of the product bag of FIG. 1;

FIG. 3 is a front view of a sterile product bag having a hollow fiber membrane filter disposed in-line with a stem of the product bag in accordance with the teachings of the present disclosure;

FIG. 4 is a right side view of the sterile product bag of FIG. 3;

FIG. 5 is an expanded isometric view of the filter and stem depicted in FIGS. 3 and 4;

FIG. 6 is a perspective view of an alternative connector for use with a filter and stem such as that disclosed in FIGS. 3-5;

FIG. 7 is a side cross-sectional view of the connector of FIG. 6;

FIG. 8 is a side view of the connector of FIG. 6;

FIG. 9 is a bottom view of the connector of FIG. 8;

FIG. 10 is a top view of the connector of FIG. 8;

FIG. 11 is a front view of a filter for a sterile product bag having a single looped hollow fiber membrane contained within a filter body;

FIG. 12 is a front view of a filter for a sterile product bag having a plurality of looped hollow fiber membranes contained within a filter body;

FIG. 13 is a front view of a plurality of hollow fiber membranes secured side by side;

FIG. 14 is an isometric view of the securement device used for the plurality of hollow fiber membranes depicted in FIG. 13;

FIG. 15 is an isometric view of a fiber bundle for a product bag having a plurality of hollow fiber membranes secured in a circular holder;

FIG. 16 is an exploded perspective view of an alternative connector for use with a three-filter filter bundle;

FIG. 17 is a side exploded view of the connector of FIG. 16;

FIG. 18 is a exploded perspective view of another alternative connector for use with a seven-filter filter bundle;

FIG. 19 is a side exploded view of the connector of FIG. 18;

FIG. 20 is a bottom view of the connector of FIG. 19;

FIG. 21 illustrates a first alternative sealing arrangement for a filtered stem of the sterile product bags of FIGS. 1-4, showing the filtered stem prior to engagement with a filling nozzle;

FIG. 22 illustrates the sealing arrangement of FIG. 21, showing the filtered stem during engagement with a filling nozzle;

FIG. 23 illustrates a second alternative sealing arrangement for a filtered stem of the sterile product bags of FIGS. 1-4, showing the filtered stem in a closed and sealed configuration prior to filling a downstream product chamber;

FIG. 24 illustrates the sealing arrangement of FIG. 23, showing the filtered stem cut in an open and unsealed configuration;

FIG. 25 illustrates the sealing arrangement of FIGS. 23 and 24, showing the filtered stem cut in an open and unsealed configuration and engaged with a filling nozzle for filling the downstream product chamber;

FIG. 26 illustrates the sealing arrangement of FIGS. 23-25, showing the filtered stem subsequent to filling where tubing located downstream of the filter has been sealed closed;

FIG. 27 illustrates the sealing arrangement of FIGS. 23-26, showing the downstream tubing cut away from the downstream product chamber to facilitate integrity testing of the filter;

FIG. 28 is a detail perspective view of a vial adaptor of any of the sterile product bags of the present disclosure and an associated drug vial;

FIG. 29 is a cross sectional view of the vial adaptor of FIG. 28;

FIG. 30 is a cross sectional view of the device of the vial adaptor of FIGS. 28 and 29 attached to the drug vial and showing a frangible or breakaway valve in an open configuration;

FIG. 31 is a perspective view, with portions broken away, of a frangible or breakaway valve of the vial adaptor of FIGS. 28-30;

FIG. 32 is an end view of the frangible or breakaway valve of FIG. 31; and

FIG. 33 is a bottom view of a sheath of the vial adaptor of FIG. 28;

FIG. 34 is a front view of an alternative sterile product bag of the present disclosure having two chamber portions;

FIG. 35 is a cross-sectional view of an embodiment of a film used to construct the product bag of FIG. 34 taken generally along plane II-II of FIG. 34;

FIG. 36 is a semi-schematic front view of another alternative embodiment of a sterile product bag of the present disclosure having multiple chamber portions;

FIG. 37 is a semi-schematic side cross-sectional view taken along line 2-2 of FIG. 36, depicting the flexible sheets forming the sterile product bag, the thickness of the layers in the sheets is exaggerated for clarity;

FIG. 38 is a semi-schematic fragmentary cross-sectional view taken along the line 3-3 of FIG. 37, showing the configuration of the flexible sheets of a first embodiment of the container of the present invention without the optional, transparent high-barrier intermediate layer;

FIG. 39 is a semi-schematic fragmentary cross-sectional view of the configuration of the flexible sheets of an alternate version of the sterile product bag of FIG. 38 depicting an optional, transparent, high-barrier intermediate film;

FIG. 40 is a semi-schematic fragmentary cross-sectional view showing the laminate configuration of the flexible sheets of another alternate version of the sterile product bag of FIG. 38 depicting an optional, transparent, high barrier intermediate film;

FIG. 41 is a semi-schematic front view of an alternative version of the sterile product bag of FIG. 36 showing an additional peelable seal and buffer chamber portion provided for protecting the concentrate chamber portion against moisture vapor permeation;

FIG. 42 is a semi-schematic pictorial view of the sterile product bag of FIG. 36 showing an optional peelable concentrate chamber portion cover being removed for inspection of the concentrate prior to mixing and use;

FIG. 43 is a semi-schematic pictorial cut away view through a vertical midline of the sterile product bag of FIG. 36 demonstrating the manipulation of the bag to separate the first peelable seal to mix the contents of adjacent chamber portions;

FIG. 44 is a semi-schematic pictorial cut away view similar to FIG. 36 but demonstrating the manipulation of the sterile product bag to separate the second peelable seal to dispense mixed contents;

FIG. 45 is a cross-sectional side view of an elastomeric ambulatory pump having a filter disposed in-line with a fill port stem in accordance with the teachings of the present disclosure, before the pump has been filled with a medical fluid; and

FIG. 46 is a cross-sectional side view of the elastomeric ambulatory pump of FIG. 45, after the pump has been filled with a medical fluid.

### DETAILED DESCRIPTION

The present disclosure is directed to a novel device and method related to delivering a medical fluid to a sterile chamber such that the medical fluid in the chamber is also sterile. Generally, the sterile product bag includes at least one chamber that is provided to a hospital or pharmacist, for example, empty. On demand, the pharmacist can introduce a medical fluid such as a diluent into the empty chamber through a sterilization filter such that the fluid is sterilized and resident by itself in the previously empty chamber. In some versions, a sterile concentrate such as a medicament or nutritional concentrate can then be introduced into the sterile chamber to be mixed with the sterile diluent prior to being administered to a patient. Introduction of the concentrate can typically occur through a medication port and/or a vial adaptor fluidly connected to the sterile chamber of the product bag. In other versions, the device can include a Luer-Activate Device (LAD) or Luer-Activate Valve (LAV) fluidly connected to the sterile chamber in addition to, or instead of, a vial adaptor or medication port. In yet other versions, the sterile product bag can include an expanding bladder of an ambulatory pump, for example.

One benefit of the various disclosed arrangements is that the product bag can be provided to the pharmacist completely empty, which can substantially decrease shipping and storage costs. Moreover, because medical fluid is provided to the bag on-demand, the sterility and integrity of the diluent over the course of shipping and storing the product bag is no longer a concern.

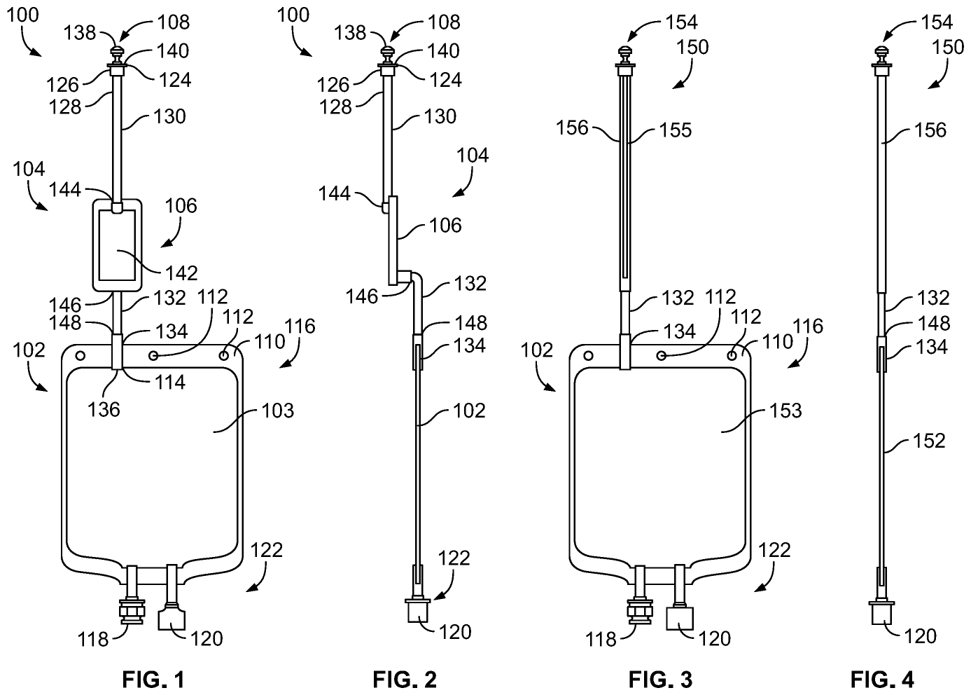

FIGS. 1 and 2 illustrate a first embodiment of the present disclosure including an empty, sterile product bag 100 that has a pre-sterilized interior and includes a bladder 102, a stem 104, a filter 106 disposed in-line with the stem 104, and a sterile closure cap 108. The bladder 102 is a fillable pouch having an interior chamber 103 having a standard volume capacity with the pre-sterilized inner environment. At least partially surrounding a perimeter of the fillable pouch is a sealed perimeter 110 having a plurality of apertures 112 configured to receive mounting hang pins during filling, administration, and/or storage. The chamber 103 of the bladder 102 is fluidly connected to the stem 104 at an opening 114 at a first end 116 of the bladder 102. An administration port 118 and a vial adaptor 120 are disposed at a second end 122 of the bladder 102. Other ports such as a medication port can be included as desired or substituted for the vial adaptor.

The stem 104 is a hollow narrow tube having an inlet 124 fluidly connected to the opening 114 of the bladder 102. The stem 104 includes a tapered head 126 defining the inlet 124, a collar 128 connecting a first stem part 130 to the tapered head 126, a second part 132, and a duct 134 defining a stem outlet 136. The sterile closure cap 108 has a hemispherical shaped knob 138 attached to a neck 140 that sealably covers the inlet 124 of the stem 104 to maintain sterility until necessary to remove the knob 138 for filling. The tapered head 126 may be a female fitting adapted for sealingly engaging a Luer fitting of a fluid supply line during filling, for example.

The filter 106 in this version has a flat sheet membrane 142 disposed in-line with the stem 104 between the first and second parts 130, 132 of the stem 104. Non-limiting examples of acceptable filter membranes for the filter membrane 142 are disclosed in U.S. Patent Publication No. 2012/0074064 A1 and PCT Publication No. PCT/EP2015/068004, the entire contents of which are incorporated herein by reference.

So configured, a pharmaceutical fluid such as a water, saline, a solution, a diluent, a final drug product, etc., may enter the inlet 124 of the stem 104 and pass through the head 126 and into the first part 130 toward an inlet 144 of the filter 106. The fluid then filters through the filter membrane 142, out a filter outlet 146, and into the second part 132 of the stem 104. The duct 134 carries the filtered solution from the second part 132 to the opening 114 of the bladder 102, which leads to the empty sterile chamber 103. The second part 132 of the stem 104 defined as the area of the stem between the outlet of the filter 146 and an inlet 148 of the duct 134 may be identified as a “seal and cut area”. The phrase “seal and cut area” pertains to the manner in which the product bags are sealed and cut after introducing fluid to the chamber 103 through the filter 106. That is, the disclosed arrangement is designed such that after the bladder 102 receives fluid from the filter 106, a sealing mechanism can be employed to seal the stem 104 closed in the “seal and cut area,” which is below the filter membrane 142 but above the bladder 102. Thus, the “seal and cut area” 132 in this version is a portion of the stem 104 above the bladder 102 where the filter 106 does not reside. Sealing of the “seal and cut area” 132 can be achieved with a heat sealer or any other device, including for example clamping a clamp onto the “seal and cut area” 132. Once the stem 104 is sealed, the stem 104 is cut at a location above the seal but below the filter membrane 142. Cutting may be achieved with a knife or any other device. The stem 104 provides an isolated fluid connection between the inlet 124 and the chamber 103 of the bladder 102, such that once the fluid is filtered through the filter membrane 142, the filtered fluid passes directly into the sterilized environment of the empty chamber 103 of the bladder 102. Hence, after the bladder 102 receives the sterilized fluid and the stem 104 is sealed and cut, the fluid in the bladder 102 remains sterile until the bladder 102 is punctured or compromised. This, of course, assumes that the filter 106 was uncompromised prior to filling and performed as desired.

To ensure that the filter 106 performed properly, a filter integrity test can be performed on the filter 106. A filter integrity test is facilitated by the arrangement of the “seal and cut area” (second part 132) of the stem 104, which allows for the filter membrane 142 to be separated intact from the remainder of the now-sealed product bag 100. For example, after the stem 104 and filter 106 are separated from the product bag 100, a filter testing device (not shown) may be pre-programmed or controlled to perform a filter integrity test on the filter 106. Examples of filter integrity tests might include a bubble point test, a pressure degradation test, a water intrusion test, a water flow test, or any suitable test known in the art. A pressure degradation test is a method for testing the quality of a filter either before or after the filter has been used. In the preferred embodiment, the filter 106 is tested after the solution passes through the filter membrane 142 and into the bladder 102 of the product bag 100. To perform the filter integrity test using a pressure degradation test procedure, a test head (not shown) engages the stem 104 and applies an air pressure of a predetermined value to the inlet 124 and filter membrane 142. In one embodiment, the pre-determined value is the pressure where gas cannot permeate the filter membrane 142 of an acceptable filter 106. A pressure sensor, or other method of measuring the integrity of the filter, is located within the test head and measures the pressure decay or diffusion rate through the filter membrane 142. The results from the integrity test are assessed to determine the quality of the filter 106, and therefore the quality of the solution that previously passed through the filter 106 and into the product bag 100. If the pressure sensor measures a decay or a unexpected rate of decay, then the filter 106 fails the test and it can be determined that the solution in the product bag is unsatisfactory. Alternatively in a bubble point test, the test head gradually increases the pressure applied to the filter 106, and the increase in pressure is measured in parallel with the diffusion rate of the gas through the filter membrane 142. Any disproportionate increase in diffusion rate in relation to the applied pressure may indicate a hole or other structural flaw in the filter membrane 142, and the filter would fail the integrity test.

Thus, it can be appreciated that the disclosed arrangement of the “seal and cut area” 132 of the product bag 100 disclosed herein advantageously facilitates the filter integrity test, and a determination that the fluid in the product bag is either sterile or has the potential of being compromised may be made with a high degree of certainty.

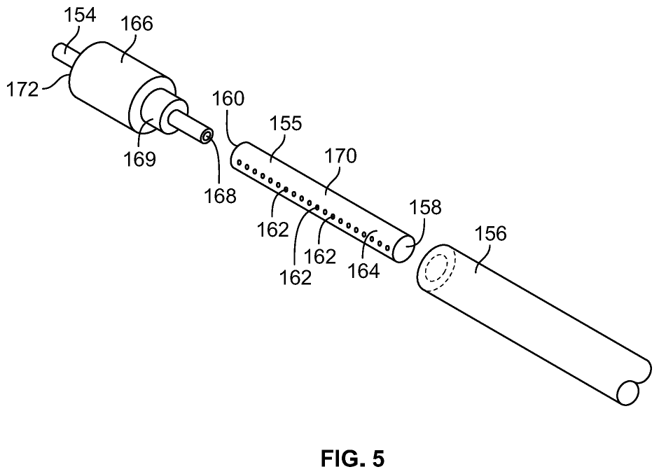

FIGS. 3-5 illustrate another embodiment of the present disclosure including a bladder 152 defining a chamber 153 and sterile closure cap 154, similar to that of the first product bag 100 in FIGS. 1 and 2. In FIGS. 3-5, the product bag 150 includes a filter 155 made from a filter membrane 170 that is disposed within (i.e., at least partially or entirely inside of) a stem 156. The stem 156, which may be tapered or cylindrical, does not provide a separate inlet and outlet connection ports for the filter 155 as illustrated in the product bag 100 of FIGS. 1 and 2. Instead, as shown in FIG. 5, the filter 155 can be a hollow fiber membrane with one sealed end 158 and one open inlet end 160. The sealed end 158 can be capped or it may be sealed with a heat seal, an adhesive, or some other means. A plurality of pores 162 along the surface 164 of the filter 155 allow a pharmaceutical fluid that entered the filter 155 at the open inlet end 160 to exit the filter 155. In one version, the stem 156 surrounds the filter membrane 170 in a generally concentric configuration so filtered pharmaceutical fluid exiting the filter membrane 170 is contained within the stem 156 and ultimately passed into the bladder 152. Again, like in FIGS. 1 and 2, the product bag in FIGS. 3-5 includes a “seal and cut area” 132 below the filter 155 and above a bladder 152, wherein the “seal and cut area 132” facilitates separation of that portion of the stem 156 containing the filter membrane 170. Because the “seal and cut area” 132 exists, the filter membrane 170 can be separated intact. As described above with respect to FIGS. 1 and 2, this “seal and cut area” 132 can advantageously facilitate an integrity test procedure on the filter 155.

As depicted in FIG. 5, a hollow connector 166 can be used to secure the stem 156 and the filter 155 together. The open inlet end 160 of the filter 155 is sealingly connected to an open outlet end 168 of the hollow connector 166. The connection may be achieved by gluing the open inlet end 160 of the filter 155 to the open outlet end 168 of the connector 166 with, for example, an epoxy resin, a polyurethane resin, a cyanoacrylate resin, a UV curing acrylic adhesive, or a solvent for the material of the hollow connector 166 such as cyclohexanone. In the version depicted, the open outlet end 168 of the connector 166 comprises a hollow cylindrical member that fits inside of and is fixed to the open inlet end 160 of the filter 155. As such, an outer diameter of the open outlet end 168 of the connector 166 is substantially similar to or slightly smaller than an inner diameter of the open inlet end 160 of the filter 155. In some versions, the open inlet end 160 of the filter 155 may be welded to the open outlet end 168 of the connector 166 by, for example, heat welding (e.g., introducing a hot conical metal tip into the open inlet end 150 of the filter 155 to partially melt it), laser welding if the hollow connector 166 is made from a material that absorbs laser radiation, mirror welding, ultrasound welding, and friction welding. Alternately, the filter 155 may be inserted into a mold, and a thermoplastic polymer may be injection-molded around it to form the hollow connector 166. Other designs and configurations for connecting the filter 155 to the connector 166 are intended to be within the scope of the present disclosure.

The hollow connector 166 further includes a fluid inlet 169. A pharmaceutical fluid can be fed via a connected fluid supply line, for example, into the fluid inlet 169 of the hollow connector 166. In some versions, the fluid inlet 169 can include a Luer type fitting or other standard medical fitting. The pharmaceutical fluid can then travel through the hollow connector 166 and exit into the filter 155 through the open outlet end 168 of the hollow connector 166. The hollow connector 166 also includes a sealing surface 172 to which the stem 156 is attached. The sealing surface 172 in this version is cylindrical and has a diameter larger than a diameter of the open outlet end 168, and is disposed generally concentric with the open outlet end 168. In fact, in this version, the outer diameter of the sealing surface 172 is generally identical to or slightly smaller than an inner diameter of the stem 156. So configured, the stem 156 receives the sealing surface 172 and extends therefrom to surround and protect the filter 155 without contacting the surface 164 of the filter 155. The stem 156 can be fixed to the sealing surface 172 with adhesive (e.g., a UV curing acrylic adhesive), epoxy, welding, bonding, etc. The stem 156 receives the pharmaceutical solution after it passes through the pores 162 in the filter 155. From there, the now filtered solution passes into the bladder 152.

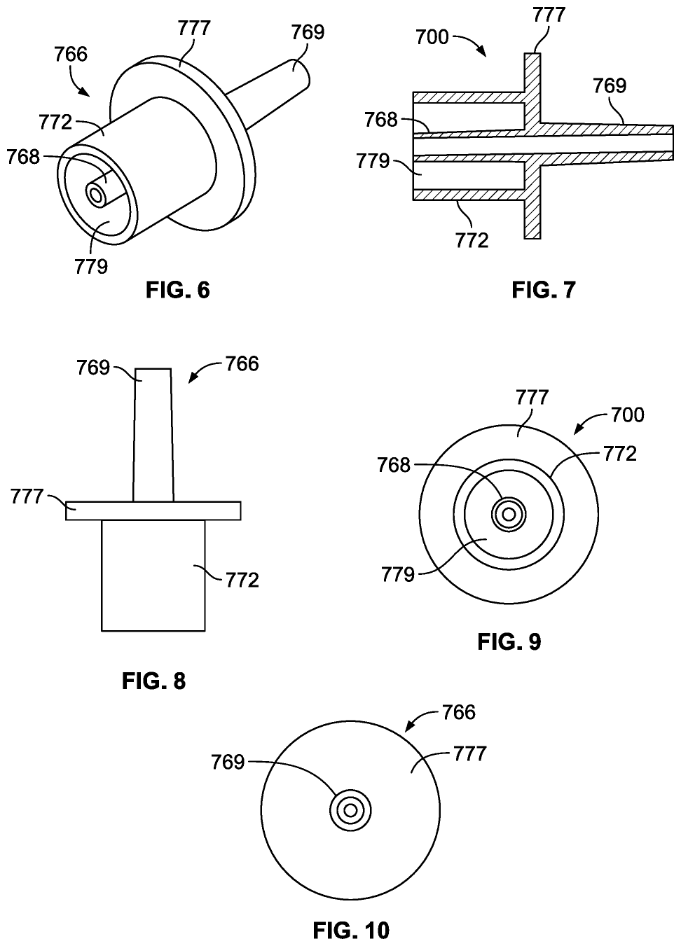

FIGS. 6-10 illustrate an alternative hollow connector 766, similar to connector 166, for securing the stem 156 and the hollow fiber filter 155 of FIGS. 3-5 together. The connector 766 includes an open outlet end 768 carried by a stem structure that extends in a first direction from a bearing plate 777 and is adapted to be sealingly connected to the open inlet end 160 of the filter 155. The connection may be achieved by gluing the open inlet end 160 of the filter 155 to the open outlet end 768 of the connector 766 with, for example, an epoxy resin, a polyurethane resin, a cyanoacrylate resin, a UV curing acrylic adhesive, or a solvent for the material of the hollow connector 766 such as cyclohexanone. In the version depicted, the stem structure of the open outlet end 768 of the connector 766 comprises a hollow cylindrical member that fits inside of and is fixed to the open inlet end 160 of the filter 155. As such, an outer diameter of the open outlet end 768 of the connector 766 is substantially similar to or slightly smaller than an inner diameter of the open inlet end 160 of the filter 155. In some versions, the open inlet end 160 of the filter 155 may be welded to the open outlet end 768 of the connector 766 by, for example, heat welding (e.g., introducing a hot conical metal tip into the open inlet end 150 of the filter 155 to partially melt it), laser welding if the hollow connector 766 is made from a material that absorbs laser radiation, mirror welding, ultrasound welding, and friction welding. Alternately, the filter 155 may be inserted into a mold, and a thermoplastic polymer may be injection-molded around it to form the hollow connector 766. Other designs and configurations for connecting the filter 155 to the connector 766 are intended to be within the scope of the present disclosure.

The hollow connector 766 further includes a fluid inlet 769, which is also a stem structure, extending in a second direction (opposite the first direction) from the bearing plate 777. A pharmaceutical fluid can be fed via a connected fluid supply line, for example, into the fluid inlet 769 of the hollow connector 766. In some versions, the fluid inlet 769 can include a Luer type fitting or other standard medical fitting. The pharmaceutical fluid can then travel through the hollow connector 766 and exit into the filter 155 through the open outlet end 768 of the hollow connector 766.

The hollow connector 766 also includes a sealing surface 772 to which the stem 156 is attached. The sealing surface 772 in this version is a cylindrical shroud extending from the bearing plate 777 in the first direction and has a diameter larger than a diameter of the open outlet end 768. The sealing surface 772 is disposed generally concentric with the open outlet end 768. As such, in this embodiment, the shroud of the sealing surface 772 surrounds the stem structure of the open outlet end 768 such that an annular gap 779 resides between the two. In fact, in this version, the outer diameter of the sealing surface 772 is generally identical to or slightly smaller than an inner diameter of the stem 156. So configured, the sealing surface 772 of the connector 766 can be received by the stem 156 such that the stem 156 extends therefrom to surround and protect the filter 155 without contacting the surface 164 of the filter 155. The stem 156 can be fixed to the sealing surface 772 with adhesive (e.g., a UV curing acrylic adhesive), epoxy, welding, bonding, etc. The stem 156 receives the pharmaceutical fluid after it passes through the pores 162 in the filter 155. From there, the now filtered fluid passes into the bladder 152 in the same manner described above with respect to FIGS. 3-5.

While the foregoing version of the filter 155 has been described as including a single filter membrane 170, in other embodiments within the scope of the present disclosure, the filter 155 may include multiple filter membranes 170. A few non-limiting examples of multiple membrane filters will be discussed below. Finally, as described with respect to the product bags 100, 150 in FIGS. 1-4, the connector 166 in FIG. 5 can include a sterile closure cap 154 covering the solution inlet 168 to prevent contaminants from entering the product bag prior to being filled.

In one version of the foregoing assembly of FIG. 5, and as mentioned, the stem 156 includes an inner diameter that is larger than an outer diameter of the filter membrane 170, and the stem 156 includes a longitudinal dimension that is larger than a longitudinal dimension of the filter membrane 170. As such, when the stem 156 and filter membrane 170 are assembled onto the connector 166, the filter membrane 170 resides entirely within (i.e., entirely inside of) the stem 156 and a gap exists between the inner sidewall of the stem 156 and the outer sidewall of the filter membrane 170. As such, fluid passing into the filter membrane 170 passes out of the plurality of pores 162 and flows without obstruction through the gap and along the inside of the stem 156 to the bladder. In some versions, the stem 156 can be a flexible tube, a rigid tube, or can include a tube with portions that are flexible and other portions that are rigid. Specifically, in some versions, a stem 156 with at least a rigid portion adjacent to the filter membrane 170 can serve to further protect the filter membrane 170 and/or prevent the filter membrane 170 from becoming pinched or kinked in a flexible tube. In other versions, such protection may not be needed or desirable. In one embodiment, the stem 156 has an internal diameter in the range of approximately 2.5 mm to approximately 8 mm, and a longitudinal dimension in the range of approximately 5 cm to approximately 30 cm. In one embodiment, the internal diameter of the stem 156 is about 0.2 to about 3 mm larger than the outer diameter of the filter membrane 170. And, the filter membrane 170 has an outer diameter in the range of approximately 2.3 mm to approximately 5 mm, a longitudinal dimension in the range of approximately 3 cm to approximately 420 cm, and a wall thickness in the range of approximately 150 μm to approximately 500 μm. Furthermore, in one version each of the plurality of pores 162 in the filter membrane 170 have a diameter less than or equal to approximately 0.2 microns. In some versions, each pore has a diameter less than or equal to a value in a range of approximately 0.1 microns to approximately 0.5 microns, for instance, approximately 0.2 to approximately 0.4 microns. In some versions, each pore has a diameter that is less than or equal to approximately 0.22 microns. In some versions, each pore has a diameter that is less than or equal to a value in a range of approximately 0.1 microns to approximately 0.2 microns. In some versions, each pore has a diameter that is less than or equal to a value in a range of approximately 0.1 microns to approximately 0.22 microns. These pore sizes coupled with the disclosed geometrical dimension of the stem 156 and filter membrane 170 ensure acceptable flow rates through the filter membrane 170 for filling the product bags with patient injectable solutions such as sterile water, sterile saline, etc. In other versions, any or all of the dimensions could vary depending on the specific application.

Suitable materials for the filter membrane 170 can include polyolefins (e.g., PE, PP), polyvinylidene fluoride, polymethylmethacrylate, polyacrylonitrile, polysulfone, and polyethersulfone. In some embodiments within the scope of the present disclosure, the filter 155 may be comprised of a blend of polysulfone or polyethersulfone and polyvinylpyrrolidone. In other embodiments within the scope of the present disclosure, the filter membrane 170 can include a polymer containing cationic charges, e.g. polymers bearing functional groups like quaternary ammonium groups. A suitable example for such polymers is polyethyleneimine. The filter membrane 170 may be manufactured by known techniques including, e.g., extrusion, phase inversion, spinning, chemical vapor deposition, 3D printing, etc. Suitable materials for the stem 156 include PVC, polyesters like PET, poly(meth)acrylates like PMMA, polycarbonates (PC), polyolefins like PE, PP, or cycloolefin copolymers (COC), polystyrene (PS), silicone polymers, etc.

Additional details regarding some possible versions of the filter and the specific construction of the membrane, for example, can be found in European Patent Application No. EP16152332.9, entitled FILTER MEMBRANE AND DEVICE, filed Jan. 22, 2016, and additionally in PCT/EP2017/051044, entitled FILTER MEMBRANE AND DEVICE, filed Jan. 19, 2017, the entire contents of each of which are expressly incorporated herein by reference.

Thus far, the hollow fiber membrane 170 in FIG. 5, for example, has been described as being located within the stem 156. In other embodiments, the filter 155 may include its own housing or other support structure, which is coupled to the stem 156 either in place of the connector 166 in FIG. 5 or connector 766 in FIGS. 6-10, or at a location between two portions of the stem 156.

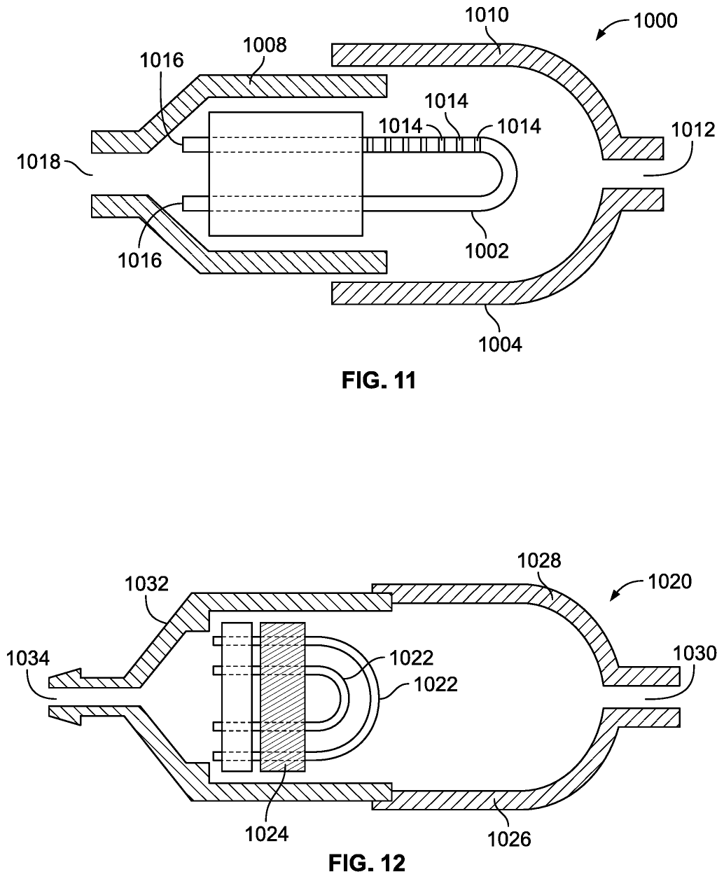

For example, FIG. 11 is a front view of a filter assembly 1000 for a product bag (not pictured) having a single U-shaped hollow fiber filter membrane 1002 contained within a filter body 1004. The filter membrane 1002 is secured to a filter membrane housing 1006 in the U-shaped configuration with an adhesive (i.e., a UV curing acrylic adhesive), an epoxy, welding, bonding, or other means. The filter membrane housing 1006 is connected to the filter body 1004 at an outlet portion 1008 of the filter body 1004. An inlet portion 1010 is sealably connected to the outlet portion 1008 of the filter body 1004 at a joint or other seam. The inlet portion 1010 of the filter body 1004 has an inlet 1012 by which a pharmaceutical fluid may enter the filter assembly 1000. The pharmaceutical fluid then enters the filter membrane 1002 through a plurality of pores 1014, travels through the filter membrane 1002, exits the filter membrane 1002 at filter membrane outlets 1016, and exits the filter body 1004 at filter outlet 1018. The filter outlet 418 may then be connected to the bladder (not pictured) via the stem 256 of a product bag (not pictured). In FIG. 11, the flow of fluid through the assembly 1000 has been described as moving from the inlet 1012 of the inlet portion 1010 to the outlet 1018 of the outlet portion 1008. However, the same assembly 400 could be used in the opposite direction such that fluid enters the outlet 1018 of the outlet portion 1008 and exits the inlet 1012 of the inlet portion 1010. In this alternative configuration, fluid would first enter the inlet 1018, pass into the filter membrane 1002 at the filter membrane outlets 1016, and exit through the pores 1014 and finally the inlet 1012.

FIG. 12 is an alternate embodiment of the filter assembly 1000 depicted in FIG. 11. In FIG. 12, the filter 1020 includes two U-shaped hollow fiber filter membranes 1022 are secured to a filter membrane housing 1024 in the U-shaped configuration with an adhesive (i.e., a UV curing acrylic adhesive), an epoxy, welding, bonding, or some other means. The filter membranes 1022 and filter membrane housing 1024 are contained within a filter body 1026 having an inlet portion 1028 with inlet 1030 sealably connected to an outlet portion 1032 having filter outlet 1034. In other embodiments, a filter may include more than two U-shaped hollow fiber filter membranes arranged as depicted in FIGS. 11 and 12. In FIG. 12, like in FIG. 11, the flow of fluid through the assembly 1000 has been described as moving from the inlet portion 1028 to the outlet portion 1032. However, the same assembly 1000 could be used in the opposite direction such that fluid enters the outlet portion 1032 and exits the inlet portion 1028 as described above relative to FIG. 11.

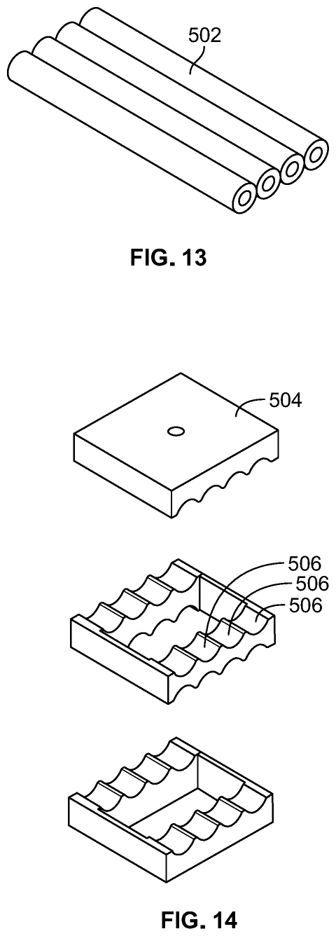

FIG. 13 is a further alternative filter assembly. Specifically, in FIG. 13, a plurality of linear membrane filters 502 are secured directly together in a parallel side-by-side configuration for what can be referred to as a fiber bundle. The filters 502 in FIG. 13 can be secured together with adhesive (i.e., a UV curing acrylic adhesive), epoxy, welding, bonding, etc. In other versions, the plurality of filters 502 can be manufactured together as one piece by way of any of the manufacturing techniques described above.

FIG. 14 provides another alternative in which a securement device 504 includes a number of blocks defining a plurality of grooves 506 identical to the number of hollow fiber membrane filters 502. The blocks of the securement device 504 may be sandwiched together and used to hold the plurality of hollow fiber membrane filters 502 in the side-by-side configuration. The securement device 504 depicted in FIG. 14 allows for two sets of the hollow fiber membrane filters 502 of FIG. 13 to be stacked relative to each other. The fiber bundle including the membrane filters 502 and the securement device 504 may be placed in a filter body, such as that discussed with respect to FIGS. 11 and 12.

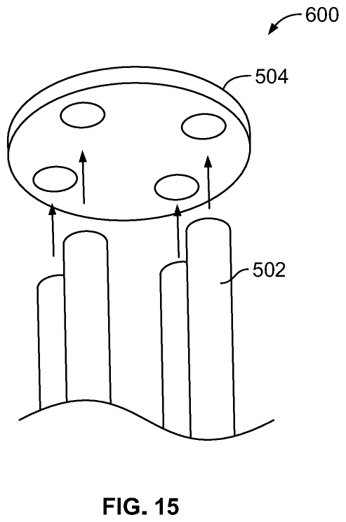

FIG. 15 is an isometric view of another version of a fiber bundle 600 for a product bag (not pictured) having a plurality of parallel hollow fiber membrane filters 502 similar to FIGS. 13 and 14, but wherein the parallel filters 502 are arranged in a circular pattern by a circular holder 504. The fiber bundle 600 may be placed in a filter body, such as that discussed with respect to FIGS. 11 and 12.

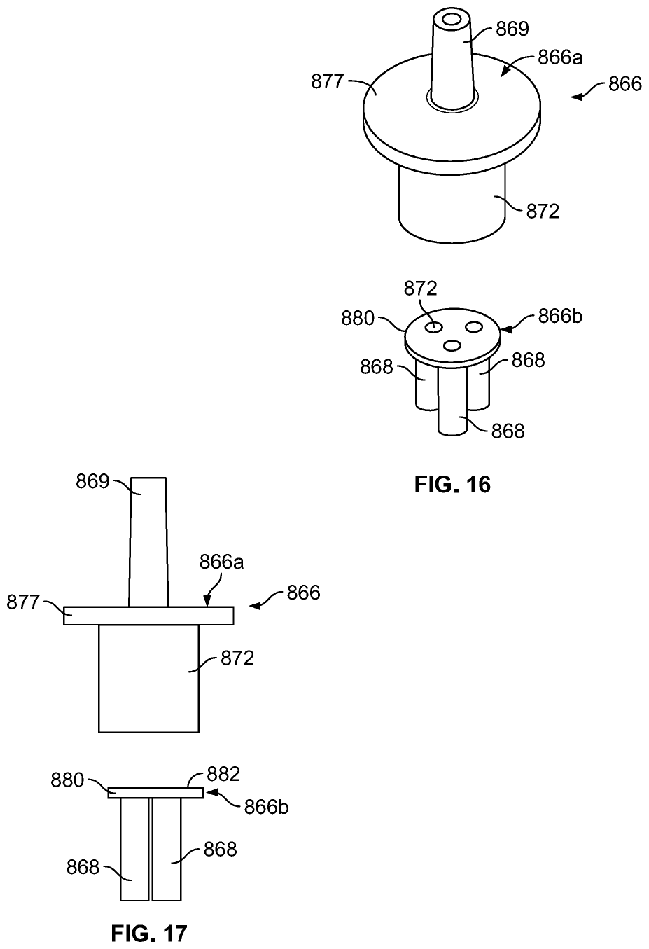

FIGS. 16-17 and FIGS. 18-20 illustrate two additional devices for coupling fiber bundles to a stem in accordance with the present disclosure. FIGS. 16-17 discloses a connector 866 for connecting a three-fiber bundle to a stem. Specifically, the connector 866 includes a first hollow body 866a and a second hollow body 866b. The first body 866a includes a solution inlet 869, which is a stem structure, extending from a bearing plate 877. A pharmaceutical fluid can be fed via a connected fluid supply line, for example, into the fluid inlet 869 of the first hollow body 866a of the connector 866. In some versions, the fluid inlet 869 can include a Luer type fitting or other standard medical fitting.

The hollow connector 866 also includes a sealing surface 872 to which the stem 156 is attached. The sealing surface 872 in this version is a cylindrical shroud extending from the bearing plate 877 in a direction opposite to a direction of extension of the fluid inlet 869. The sealing surface 872 is disposed generally concentric with the fluid inlet 869. As such, in this embodiment, the shroud of the sealing surface 872 defines a cylindrical cavity (not shown in the drawings) for receiving a portion of the second hollow body 866b of the connector 866.

The second hollow body 866b, as depicted, includes a support plate 880 and three open outlet ends 868 extending from the support plate 880. Additionally, the support plate 880 includes an outer diameter that is essentially the same as or slightly smaller than an inner diameter of the cavity of the shroud of the sealing surface 872 such that when assembled, the support plate 880 is positioned into the cavity. In one version, the support plate 880 includes a seal member 882 around its periphery to form a fluid tight seal with the inner surface of the shroud of the sealing surface 872 when inserted into the cavity. Friction, adhesive, or some other means may retain the support plate 880 in connection with the shroud of the sealing surface 872.

As mentioned, the second body 866b includes three open outlet ends 868 extending from the support plate 880. Each open outlet end 868 is adapted to be sealingly connected to an open inlet end 160 of one of three filters 155. The connection may be achieved by gluing open inlet ends 160 of the filters 155 to the open outlet ends 868 with, for example, an epoxy resin, a polyurethane resin, a cyanoacrylate resin, a UV curing acrylic adhesive, or a solvent for the material of the hollow connector 766 such as cyclohexanone. In the version depicted, the stem structure of the open outlet ends 868 of the connector 866 comprises a hollow cylindrical member that fits inside of and is fixed to the open inlet ends 160 of the filters 155. As such, an outer diameter of the open outlet ends 868 is substantially similar to or slightly smaller than an inner diameter of the open inlet ends 160 of the filters 155. In some versions, the filters 155 may be welded to the open outlet ends 868 of the connector 866 by, for example, heat welding (e.g., introducing a hot conical metal tip into the open inlet ends 150 of the filters 155 to partially melt it), laser welding if the hollow connector 866 is made from a material that absorbs laser radiation, mirror welding, ultrasound welding, and friction welding. Alternately, the filters 155 may be inserted into a mold, and a thermoplastic polymer may be injection-molded around it to form the hollow connector 866. Other designs and configurations for connecting the filters 155 to the open outlet ends 868 are intended to be within the scope of the present disclosure.

Finally, as with previously described embodiments, the sealing surface 872 of the connector 866 can be received by the stem 156 such that the stem 156 extends therefrom to surround and protect the filters 155 without contacting the surfaces 164 of the filters 155. The stem 156 can be fixed to the sealing surface 872 with adhesive (e.g., a UV curing acrylic adhesive), epoxy, welding, bonding, etc. The stem 156 receives the pharmaceutical solution after it passes through the pores 162 in the filter 155. From there, the now filtered solution passes into the bladder 152 in the same manner described above with respect to FIGS. 3-5.

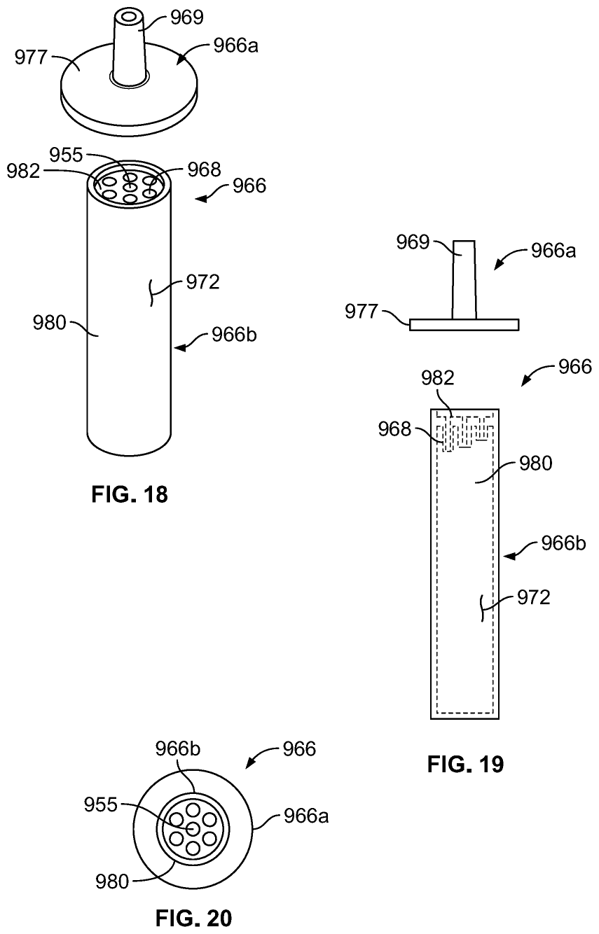

FIGS. 18-20 discloses a connector 966 for connecting a seven-fiber bundle to a stem. Specifically, the connector 966 includes a first hollow body 966a and a second hollow body 966b that can be connected to the first hollow body 966a with an adhesive or via other means. The first body 966a includes a solution inlet 969, which is a stem structure, extending from a bearing plate 977. A pharmaceutical fluid can be fed via a connected fluid supply line, for example, into the fluid inlet 969 of the first hollow body 966a of the connector 966. In some versions, the fluid inlet 969 can include a Luer type fitting or other standard medical fitting.

The second hollow body 966b, as depicted, includes a hollow cylindrical support collar 980 in which seven hollow fiber membrane filters 955 can be disposed parallel to each other, as shown in FIGS. 18 and 20. In one version, the support collar 980 can include a support plate 982 carrying seven open outlet ends 968 extending into the collar 980 for connecting to the filters 955 in a manner similar to that described above regarding FIGS. 16-17. The connection may be achieved by gluing the filters 955 to the open outlet ends 968 with, for example, an epoxy resin, a polyurethane resin, a cyanoacrylate resin, a UV curing acrylic adhesive, or a solvent for the material of the hollow connector 966 such as cyclohexanone. In the version depicted, the stem structure of the open outlet ends 868 of the connector 866 comprises a hollow cylindrical member that fits inside of and is fixed to the filters 955. As such, a diameter of the open outlet ends 968 is substantially similar to or slightly smaller than an inner diameter of the filters 955. In some versions, the filters 955 may be welded to the open outlet ends 968 of the connector 966 by, for example, heat welding (e.g., introducing a hot conical metal tip into the filters 955 to partially melt it), laser welding if the hollow connector 966 is made from a material that absorbs laser radiation, mirror welding, ultrasound welding, and friction welding. Alternately, the filters 955 may be inserted into a mold, and a thermoplastic polymer may be injection-molded around it to form the hollow connector 966. Other designs and configurations for connecting the filters 955 to the open outlet ends 968 are intended to be within the scope of the present disclosure.

Finally, the collar 980 of this embodiment includes a sealing surface 972 that can be received by the stem 156 such that the stem 156 extends therefrom. The stem 156 can be fixed to the sealing surface 972 with adhesive (e.g., a UV curing acrylic adhesive), epoxy, welding, bonding, etc. The stem 156 receives the pharmaceutical fluid after it passes through the pores 162 in the filters 955. From there, the now filtered fluid passes into the bladder 152 in the same manner described above with respect to FIGS. 3-5.

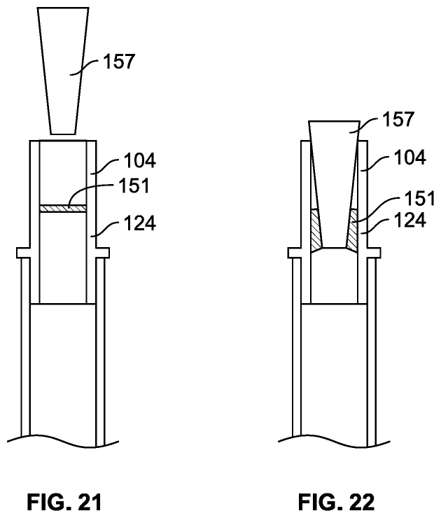

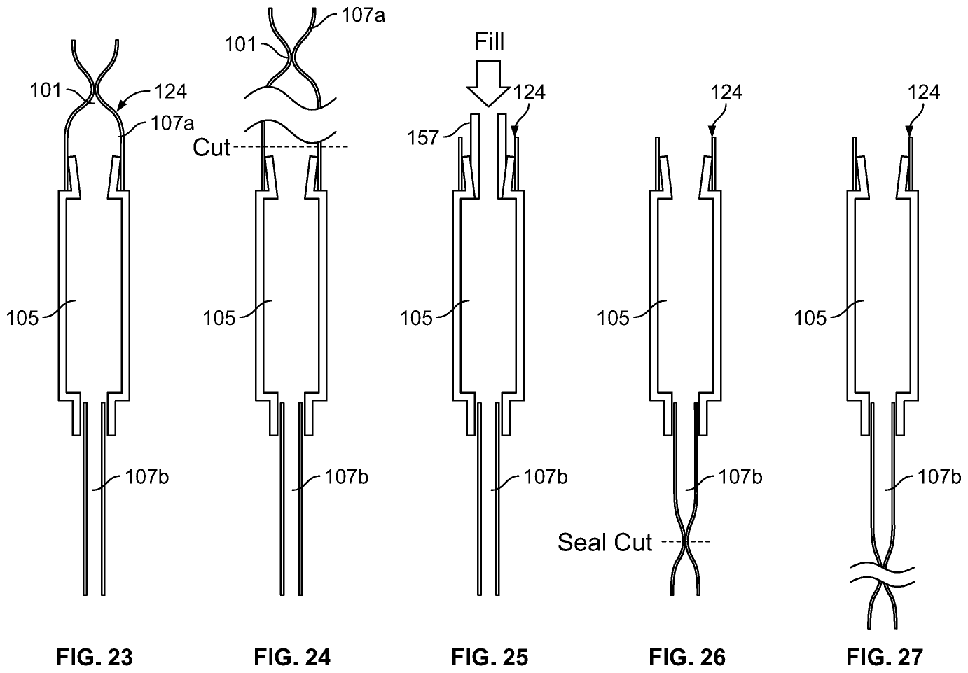

As discussed above, some embodiments of the disclosed systems include a knob 138, as depicted in FIGS. 1-4, that sealably covers the inlet 124 of the stem 104 to maintain sterility until time for filling. Instead of the knob 138, other embodiments can include a split septum or membrane 151 disposed in the stem 104, as depicted in FIGS. 21 and 22. Prior to and possibly after filling, the septum or membrane 151 provides a sterile closure at the inlet 124 of the stem 104 as depicted in FIG. 21. But the septum or membrane 151 can be punctured or opened by a filling port 157 inserted into the stem 104 during the filling process, as illustrated in FIG. 22. Still other embodiments can be constructed differently. For example, FIGS. 23-27 illustrate an alternative version where neither a knob 138 now a septum or membrane 151 is required. Instead, as shown in FIG. 23, the inlet 124 of the stem 104 can be closed or sealed off with a seal 101 such as a heat seal or otherwise. More particularly, FIGS. 23-27 illustrate a filter 105 disposed between an upper stem portion 107a and a lower stem portion 107b. The upper and lower stem portions 107a, 107b can be any medically suitable material, which may be rigid or flexible and suitable for the intended use, and affixed to opposite ends of the filter 105 with an adhesive, by welding, or otherwise, as shown. So configured, prior to filling a product bag (not shown) that is located downstream from the filter 105, the upper stem portion 107a is cut at a location between the seal 101 and the filter 105, as shown in FIG. 24. This exposes the inlet 124 opening to allow for the receipt of a filling nozzle 157, as shown in FIG. 25. Once filling is complete, the lower stem portion 107b is sealed and cut in a manner similar to that described above with previous versions to both seal the downstream chamber to maintain it sterility, and remove the filter 105 for integrity testing.

From the foregoing, it can be seen that various filtering arrangements can serve the principles of the present disclosure including introducing fluid to the product bag in a sterilized manner. In some versions of the disclosure, this fluid can then be mixed with a concentrate (e.g., medicament, drug, nutrient, etc.) that is introduced into the product bag 100, 150 through the vial adaptor 120 depicted and mentioned with respect to FIGS. 1-4.

That is, as mentioned above, the sterile product bags 100, 150 described in FIGS. 1-4 may further include vial adaptors 120 for coupling to a drug vial and introducing a drug or nutritional concentrate from the drug vial to the chamber 103, 153. The vial adaptor 120 can take many different forms, but one example is disclosed in U.S. Pat. No. 5,304,163, entitled INTEGRAL RECONSTITUTION DEVICE, the entire contents of which are incorporated herein by reference.

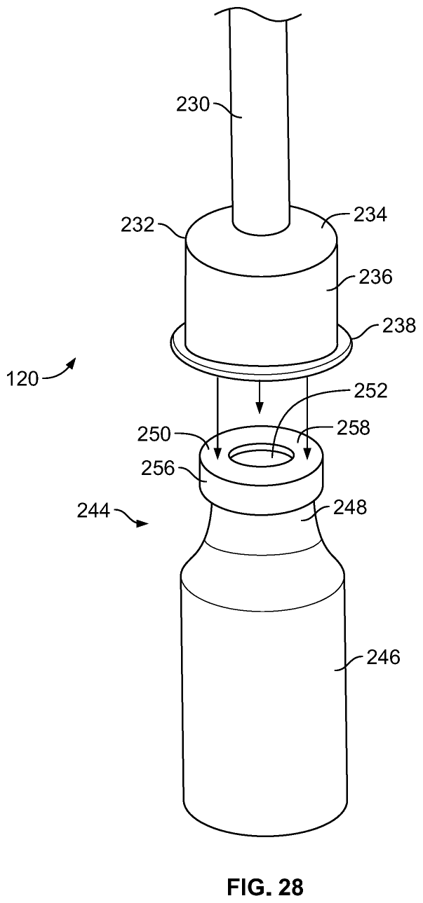

Referring to FIG. 28, one version of a vial adaptor 120 includes flexible tubing 230 in fluid communication with the chamber 103, 153 of the sterile product bag 100, 150. Extending from the lower periphery of the flexible tubing 230 is an open ended sheath 232 which includes a base 234 and a skirt 236 projecting downwardly therefrom. A outwardly extending flange 238 is provided at the lower periphery of the skirt 236. Secured in a sealing engagement around the open end of the skirt 236 over the outwardly extending flange 238 is a peelable closure 240.

The present vial adaptor 120 is adapted to be used in conjunction with a standard sized drug vial 244 which is also shown in FIG. 28. The drug vial 244 is typically made of an optically transparent glass or plastic, and includes a body 246, a neck 248 and a mouth 250. A resilient stopper 252 typically made of an elastomer is mounted within the mouth 250 to serve as an access site to the interior chamber of the drug vial 244.

The drug vial 244 typically further includes a malleable band 256 typically made of aluminum which is mounted about the outer periphery of the mouth 250 and the stopper 252, thereby retaining the stopper 252 within the drug vial 244. Typically, the malleable band 256 initially includes a top portion (not shown) covering the top of the stopper 252. This top portion is separated from the malleable band 256 by means of a weakened score line 258 disposed at the inner circle of the malleable band 256. This top portion is removed to provide access to the stopper 252.

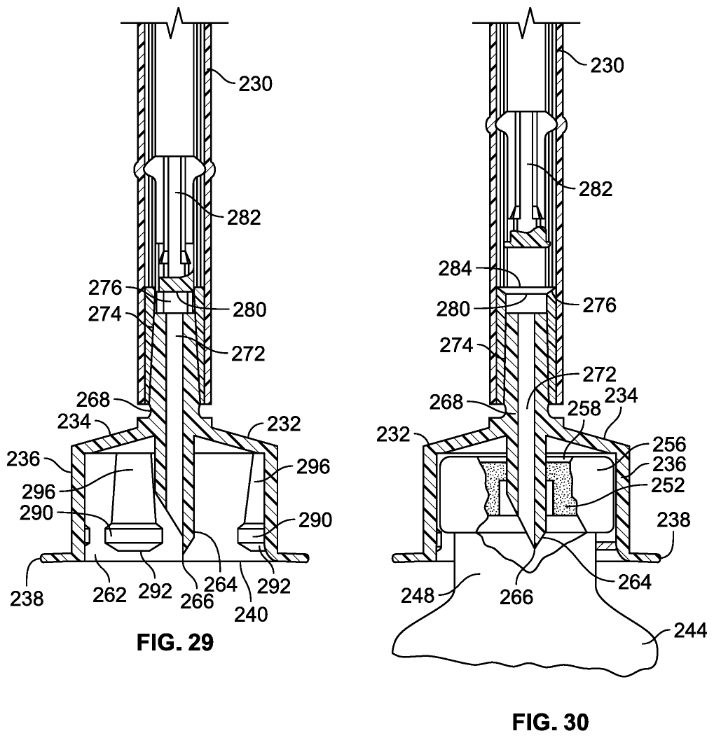

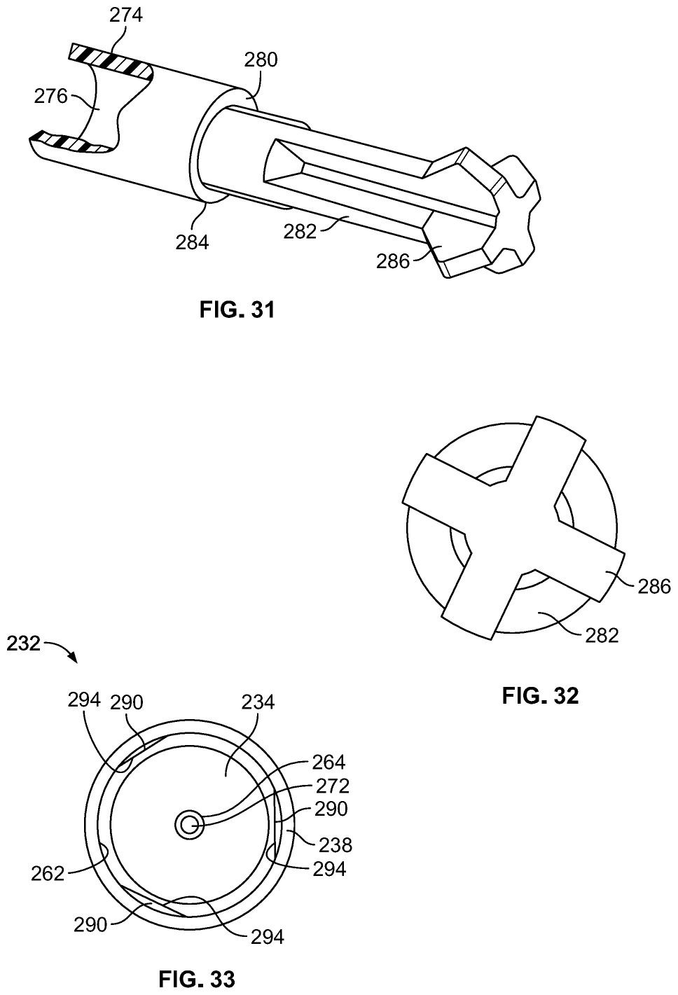

Referring now to FIGS. 29 through 32, the skirt 236 defines an interior surface 262. Contained within the sheath 232 is a sharp, hollow cannula 264 which extends about the center axis of the skirt 236. The entire cannula 264 is contained within the sheath 232 with the sharp point 66 of the cannula 264 contained recessed from a plane defined by the open end of the skirt 32 and the outwardly extending flange 238. This recessed cannula 264 acts to reduce accidental “sticks” of personnel handling the vial adaptor 120 as well as touch contamination. Additionally provided about the open end of the sheath 232 is the peelable closure 240. The peelable closure 240 is preferably made of aluminum foil or other suitable barrier materials to bacteria and dirt. The peelable closure 240 is provided with a heat activated adhesive such that the peelable closure 240 is secured to the sheath 232 by heat sealing. The peelable closure 240 ensures sterility of the presterilized vial adaptor 120 during storage and provides evidence of pre-use tampering.

Extending into the flexible tube 230 and molded integrally with the sheath member 32 is housing 68 defining a lumen 272. The lumen 272 is in fluid communication with the cannula 264. Thus, when the sheath 232 is placed over a drug vial 244 and the cannula 264 is inserted through the stopper 252 into the interior of the drug vial 244, open fluid communication is established between the interior of the drug vial 244 and the lumen 272.

Sealingly permanently engaged to the outer periphery of the lumen housing 268 and to the flexible tube 230 is a frangible or breakaway valve housing 274. The valve housing 274 is permanently secured to the interior of the flexible tubing 230 by solvent bonding or heat sealing. The valve housing 274 includes a tubular aperture 276 in fluid communication with the lumen 272. The lumen housing 268 is preferably tapered from an initial diameter to a smaller inner diameter. The valve housing 274 is preferably cooperatively tapered from an initial interior diameter to a smaller interior diameter. The taper of the outside diameter of the lumen housing 68 cooperates with the taper of the inside diameter of the valve housing 274 to form a tight fit. Additionally, the valve housing 274 and the lumen housing 268 are permanently sealed by means such as solvent bonding, heat bonding or other bonding techniques known in the art.

The tubular aperture 276 includes a normally closed end 280. The normally closed end 280 has extending from and integral with it an elongated, generally rigid handle 282. The normally closed end 280 further includes an annular zone of weakness 284 to facilitate breaking the handle 282 from the valve housing 274 thereby opening the valve. The valve housing 274 and the handle 282, which form the valve, are preferably a molded, chemically inert, rigid plastic. In a preferred embodiment, this plastic can be polyvinyl chloride.

The handle 282 includes a plurality of outwardly extending projections 86 which frictionally fit within the interior of the flexible tubing 230. The outwardly extending projections 286 dig into the interior of the tubing 230 and hold the handle in position after it is broken away from the closed end. This assures that fluid can flow in two directions, one way to provide fluid into the drug vial 244 and the opposite way to provide liquid from the drug vial 244 into the chamber 103, 153 of the sterile product bags 100, 150, without the handle 282 moving back into contact with the normally closed end 280 and blocking fluid flow.

Referring now to FIG. 33 in conjunction with FIGS. 20 and 30, the sheath 232 includes a plurality of inwardly projecting bumps 290 intermittently spaced about the interior surface 262 of the skirt 236. The bumps 290 are all disposed a substantially equal distance from the base 234. This distance is substantially equal to the width of the malleable band 256 on the drug vial 244.

The bumps 290 are preferably spaced equal distance radially about the inner surface 262 of the skirt 236. Each bump 290 preferably includes a sloped side 292 facing the open end of the skirt 236. The slope side 292 extends to a plane 294 which represents the maximum internal projection of the bump 290. The plane 294 of maximum projection tapers on the base side to an elongated narrow plane 296 extending from the plane 294 of maximum projection to the base 234. The slope side 292 preferably defines an angle of about 30° from the inner surface 262 while the plane 294 of maximum projection is preferably at least about 0.026 inches from the inner surface 262.

The skirt 236 is preferably made of a semi-rigid material such as a polycarbonate or other suitable polymer. The semi-rigid skirt 236 assists in creating a tight fit between the vial adaptor 120 and a wider size range of drug vials 244.

With a product bag 100, 150 arranged as described in FIGS. 1-4, the product bag 100, 150 is initially delivered to a pharmacist entirely empty. That is, the chamber 103 is devoid of any material and, moreover, has been pre-sterilized through conventional sterilization techniques including, for example, steam sterilization or any other sterilization process. Thus, it can be appreciated that in order to reconstitute a drug or a nutrient from concentrate, the concentrate and a diluent must be introduced into the chamber 103, 153 and mixed.

The first step for the pharmacist then is to introduce a diluent into the empty, sterile chamber 103, 153 through the filtered stem 104. As described above with respect to any of FIGS. 1-27, each of the filters, filter membranes, filtration devices, etc., are equipped to sterilize the diluent as the diluent passes therethrough and into the chamber 103, 153. This introduction of the diluent can be achieved either manually, automatically, or semi-automatically. One possible automatic system and process that may be utilized is disclosed in PCT/US17/14264, entitled METHOD AND MACHINE FOR PRODUCING STERILE SOLUTION PRODUCT BAGS, the entire contents of which are incorporated herein. In one version where the stem 104 includes the sealing knob 138 depicted in FIGS. 1-4, this process simply requires removing the knob 138 and introduces a filling port into the stem 104. In other embodiments that include a septum or membrane 151 as depicted in FIGS. 4A, the filing port 157 is simply introduced into the stem to pierce the septum or membrane 151 and begin introducing diluent to the chamber 103, 153.

Then, once the desired amount of diluent is added to the chamber 103, 153, the stem 104 is sealed and cut at the second part 132 of the stem 104 as discussed above regarding FIGS. 1-4. This ensures that the stem 104 is completely sealed. Moreover, this enables the performance of a filter integrity test on the filter. If the filter passes the test, the sterility of the diluent introduced into the chamber 103, 153 is confirmed. If the filter doe snot pass the test, the diluent and product bag may have to be discarded as the sterility of the diluent may be considered compromised or of lesser than desired sterility. In those instances where the filter passes the filter integrity test, the product bag 100, 150 and diluent can be used to reconstitute a concentrate provided by a drug vial, for example.

In this regard, a drug vial 244 of standard construction is introduced and installed onto the vial adaptor 120 by removing the foil closure 240 and simply pushing the sharp cannula 264 through the stopper 252. This penetration can be aided by use of a suitable lubricant on the cannula such as a silicon oil. The internal diameter of the skirt 236 is sized to approximate the outer diameter defined by the malleable band 256 used on most drug vials 244 of standard construction. Because the precise drug vial 244 dimensions vary throughout the industry, a tight fit is insured by the bumps 290, which create a stop against the underside of the malleable band 256, making inadvertent disconnection of the device and the drug vial 244 difficult.

The fit between the skirt 236 and the drug vial 244 is tight enough so that in most instances the bumps 290 deform the malleable band 256. This results in the creation of vertical grooves in the side of the malleable band 256 as the skirt 236 is pushed down about the mouth 48 of the drug vial 244. If the malleable band 256 is wider than average, there may be no space between the top of the malleable band 256 and the base 234 of the sheath 232. The width of the malleable band 256 may actually equal or even slightly exceed the distance between the base 234 and the base side of the bumps 290. In situations with wider malleable bands 56, the bumps 290 deform the underside of the malleable band 256 by causing indentation where the bumps 290 contact the underside.

After the sharp cannula 264 has been inserted into the drug vial 244 and fluid communication has been established between the interior of the drug vial 244 and the lumen 272, the vial adaptor 120 can be stored for an extended period of time prior to use. This is because the permanently secured, integral design of the vial adaptor 120 allows for presterilization of the entire unit, including the sterile product bags 100, 150, the flexible tubing 230, and the sheath 232. With the use of the peelable closure 240, the sterility of the vial adaptor 120 during storage as well as the aseptic connection to drug vials 244 is assured. This assurance of sterility results in the availability of extended periods of storage prior to use.

When the drug is to be reconstituted, fluid communication can be established between the interior of the drug vial 244 and the chamber 103, 153 of the sterile product bag 100, 150 by opening the frangible or breakaway valve. To open the valve, the user can simply grasp the flexible tubing 230 to break the handle 282 from the valve housing 274 at the weakened score line 284. The valve housing 274 remains in place within the flexible tubing 230 since it is bonded to the interior of the flexible tubing 230. The outwardly extending projections 86 of the handle 282 maintain frictional contact with the interior of the flexible tubing 230 as the valve is opened and the handle 282 is “walked” down the flexible tubing 230 by manually bending and releasing the flexible tubing 230. A force created by folding the flexible tubing 230 back upon itself “walks” the handle 282 down the flexible tubing 230 where it remains after the force is released. The handle 282 can be “walked” further down the flexible tubing 230 by again folding the flexible tubing 230 back upon itself and releasing. The outwardly extending projections 86 assure that the handle 282 remains away from the aperture 276 by frictionally “biting” into the flexible tubing 230. At this point, the user takes generally conventional steps to reconstitute the concentrate in the vial 244. Specifically, the user squeezes the product bag 100, 150, which forces some of the diluent into the drug vial 244. Then by manipulating the orientation of the vial 244 of the product bag 100, 150 the diluent and concentrate begin to mix abd flow back and forth between the vial 244 and the bag 100, 150. By holding vial 244 upside down above the product bag 100, 150, the user can determine when a mixed concentrate has sufficiently moved out of the vial 244 and into the chamber 103, 153 with diluent. At this point, the product bag 100, 150 can be manually manipulated to thoroughly mix the concentrate and diluent into solution. When satisfactorily mixed, the solution may be delivered to the patient by connecting the administration port 118 to a conventional delivery set.

Thus far, only sterile product bags 100, 150 with single chambers 103, 153 have been discussed. But the benefits of the present disclosure can also be realized in sterile product bags with more than a single chamber. As an example, one conventional dual-chamber product bag that can benefit from the technologies disclosed in the present application is disclosed in U.S. Pat. No. 5,577,369, entitled METHOD OF MAKING AND FILLING A MULTI-CHAMBER CONTAINER, the entire contents of which are incorporated herein by reference.

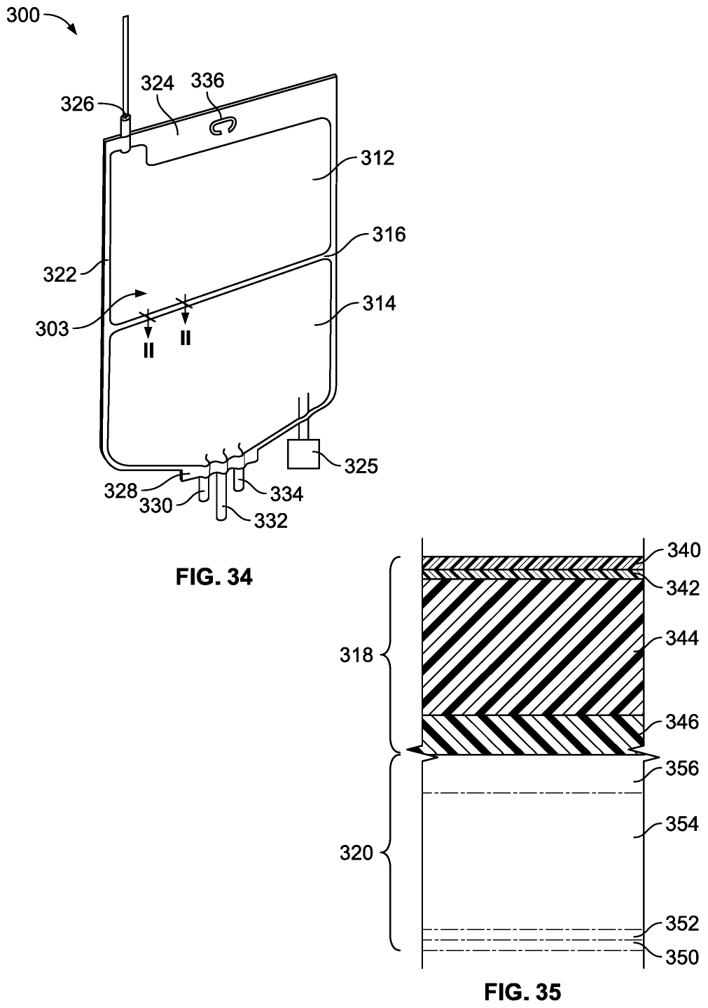

Referring to FIG. 34, a dual-chambered sterile product bag 300 is generally shown. The product bag 300 includes a chamber 303 separated into two chamber portions 312 and 314 for the separate storage of substances and/or solutions. A peelable seal 316 is provided between the chamber portions 312, 314. Although in the embodiment illustrated, the product bag 300 includes two chamber portions 312, 314, it should be appreciated that additional peelable seals may be included to divide the chamber 303 into additional chamber portions.

The product bag 300 is formed from a flexible sheet of plastic. The bag 300 may be formed from two sheets of film that are heat sealed along their edges defining a perimeter seal 305. However, the bag 300 can be formed from a web of film folded over and sealed along three sides. Pursuant to the present invention, the bag 300 is formed from a multi-layer film discussed below.

In the illustrated embodiment as shown in FIG. 35, two sheets of film are used. A first or front sheet 318 and a second or rear sheet 320 are sealed about the periphery 322 of the bag 300 by, for example, heat sealing. The peelable seal 316, described more fully below, is provided between the sheets 318, 320 to form the chamber portions 312, 314.

In the preferred embodiment illustrated in FIG. 34, at a top end 324 of the product bag 300 includes a stem 326 equipped with a filter arrangement for sterilizing fluid passing through the stem 326 and into the first chamber portion 312. The filter arrangement can include any of the filters, filters, membranes, and filtration devices described above with respect to FIGS. 1-20. As such, the details will not be repeated.

Still referring to FIG. 34, a bottom end 328 of the product bag 300, in the illustrated embodiment, can potentially include three tubular ports 330, 332, and 334 and an optional vial adaptor 325. More or less than the three tubular ports 330, 332, 334 can be included. Embodiments of the ports 330, 332, 334 can include an administration port, a medication port having a solid or slit septum, a Luer Activating Valve or other designs to provide communication to the interior of the product bag 300. The vial adaptor 325 allows the second chamber portion 314 to be filled with a concentrate from a drug vial, same as that described above with respect to FIGS. 28-33. As such, the details of the vial adaptor 325 will not be repeated. The tubular ports 330, 332, and 334 can allow the medical substances contained within the product bag 300 to be discharged to one or more patients. Similarly, the tubular ports 330, 332, and 334 can allow medicaments to be injected into the bag 300.

The tubular ports 330, 332, and 334 are mounted in the product bag 300 to communicate with the product bag 300 via the chamber portion 314. The ports 330, 332, and 334 can include a membrane or septum that is pierced by, for example, a cannula or a spike of an administration set for delivery of the contents of the product bag 300 through the administration set to the patient. Of course, more or less than three ports can be included.

Preferably, at the top end 324 of the product bag 300 is an area which includes a hanger hole 36 for supporting the product bag 300 by, for example, a hook (not shown).

In FIG. 35, the sheets 318, 320 which form the bag 300 are illustrated in cross-sectional view. Specifically, the seal 316 is illustrated at the junction of the sheet 318 with the sheet 320. The seal 316 is formed such that no communication between the chamber portions 312, 314 is provided until the seal 316 is broken. That is, the chamber portions 312, 314 are isolated from each other when the seal 316 is intact such that fluids and gasses cannot pass from one chamber portion to the other. Rupturing or breaking the peelable seal 316 serves to provide communication between the chamber portions 312, 314 allowing a mixing of the substances stored therein.

The sheets 318, 320 are flexible and are preferably made of the same materials. In the illustrated embodiment, the first sheet 318 includes a first layer 340 forming an outer surface or abuse layer of the product bag 300. The first layer 340 may be, for example, a thermoplastic material such as PCCE. A typical thickness of the first layer 340, in a preferred embodiment, is approximately 0.55 mil but may vary, for example, between 0.40 mil and 0.70 mil.

A tie layer 342 can be provided to provide a binding layer between the outside layer 340 and a second layer 344 of the sheet 318 which is RF-responsive. Although in a preferred embodiment, the tie layer 342 has a thickness of approximately 0.4 mils, the tie layer 342 may, however, have a varied thickness, for example, between 0.25 mils and 0.55 mils. The tie layer 342 can be a thermoplastic material such as ethyl vinyl acetate (EVA) modified with malic anhydride.

The second layer 344 is an RF-responsive layer that, as discussed below, cooperates with a sealing or inner layer 346 to create the seal. The second layer 344 can be any RF-responsive material. In a preferred embodiment, the RF-responsive material is an ethyl vinyl acetate (EVA). It has been found that a layer thickness of approximately 6.2 mils functions satisfactorily. However, the second layer 344 can have a varied thickness of between, for example, at least 5.75 mils and 6.75 mils.

The sealing layer 346 is made of a non-RF responsive material. Preferably, the non-RF responsive layer includes at least two materials having different melting points. In an embodiment, the non-RF-responsive layer is an alloy of styrene-ethylene-butyl-styrene (SEBS) for example, Kraton®, and ethylene polypropylene copolymer. It has been found that if the sealing layer has a thickness of approximately 1.6 mils it functions satisfactorily. However, the thickness may vary, for example, between 1.40 mils and 1.80 mils.

The sealing layer 346 is adjacent the solution side of the container such that when the seal 316 is ruptured, communication is provided between the chamber portions 312, 314. As noted above, the four-layer film illustrated in FIG. 35 has at least one RF-responsive layer 344 and one non-RF responsive layer 346. A RF field heats a seal bar 62 (not shown) which heats the RF-responsive layer 344 which, in turn, heats the non-RF responsive layer 346 to soften the layer 346, but not liquify same. A resulting cohesive bond develops from contact between the non-RF responsive layer 346 of the sheet 318 and a corresponding non-RF responsive layer 456 of the sheet 320, but fusion between the layers, which can cause permanent bonding, does not occur.

As previously indicated, the product bag 300 can be formed by folding a single web, such as the sheet 318, or alternatively, the sheet 320 can be further provided in addition to the sheet 318. In the preferred embodiment, the sheet 320 is a four-layer film in which layers 50, 52, 54 and 56 of the sheet 320 substantially correspond to the layers 40, 42, 44 and 46 of the sheet 318, respectively. As a result, the sealing layer 456 of the sheet 320 forms a cohesive bond with the sealing layer 346 of the sheet 318. The cohesive bond formed is the peelable seal 316.

It should be appreciated that fewer layers for each of the sheets 318, 320 than the four-layer film described with reference to FIG. 35 can be used to create the peelable seal 316 of the present invention. Two layers can be used, one layer being RF-responsive and the other layer being non-RF responsive. Reliability and strengthening of the peelable seal 316 may be further enhanced by using corona treatment or an extrusion process.

The peelable seal 316 is preferably formed to withstand external pressure to one or both chamber portions 312, 314 of the container. Furthermore, the peelable seal 316 is capable of withstanding pressure exerted by dropping the product bag 300 either on its side or if it is dropped flat. Preferably, the peelable seal 316 can withstand rupture from a drop of up to six feet.

Post-sterilization of the chamber portions 312, 314 of the product bag 300 substantially increases the pressure which the peelable seal 316 is capable of withstanding before rupture. More specifically, sterilization can increase seal strength between 40 and 80 percent.

During use, the product bag 300 can be supplied to a pharmacist in one of two manners. In the first manner, the first and second chamber portions 312, 314 of the bag 300 are entirely empty, while in a second manner, the first chamber portion 312 is empty but the second chamber portion 314 can be pre-filled with a concentrate requiring reconstitution. The concentrate may be in the form of powder, gel, foam, liquid, flakes, etc.

To perform reconstitution when both chamber portions 312, 314 are completely empty, the pharmacist can first introduce a diluent to the first chamber portion 312 through the filtered stem 326 in a manner same as that described above with reference to the product bags 100, 150 in FIGS. 1-20. Subsequently, the filtered stem 326 can be sealed, cut, and integrity tested. If the filter passes the integrity test, the pharmacist can determine that the diluent in the first chamber portion 312 is sufficiently sterile to continue. Next, the pharmacist can introduce a concentrate to the second chamber portion 314 through the vial adaptor 325 in a manner identical to that described above with reference to FIGS. 28-33. With the first chamber portion 312 containing diluent and the second chamber portion 314 containing concentrate, a user can apply a compressive force to the outside of the product bag 300 in the region of the first chamber portion 312, which creates a hydraulic force applied to the peel seal 316 ultimately breaking the peel seal 316 and causing fluid communication between the first and second chamber portions 312, 314. Continued manual manipulation of the product bag 300 mixes the concentrate and diluent thoroughly to arrive at a solution ready for patient administration.

In the alternative version where the product bag 300 arrives at the pharmacist with pre-filled concentrate in the second chamber portion 314, the foregoing steps are the same except the pharmacist is not required to utilize the vial adaptor 325 to introduce the concentrate to the second chamber portion 314. Thus, in the pre-filled concentrate version, the product bag 300 does not need to have the vial adaptor 325 at all.

While the foregoing describes a two chamber product bag 300 in accordance with the present disclosure, other alternatives can include additional chambers an/or additional features. For example, one example of a multi-chamber product bag that can benefit from the present advancements includes that which is disclosed in U.S. Pat. No. 6,165,161, entitled SACRIFICIAL PORT FOR FILLING FLEXIBLE, MULTIPLE-COMPARTMENT DRUG CONTAINER, the entire contents of which are incorporated herein by reference.

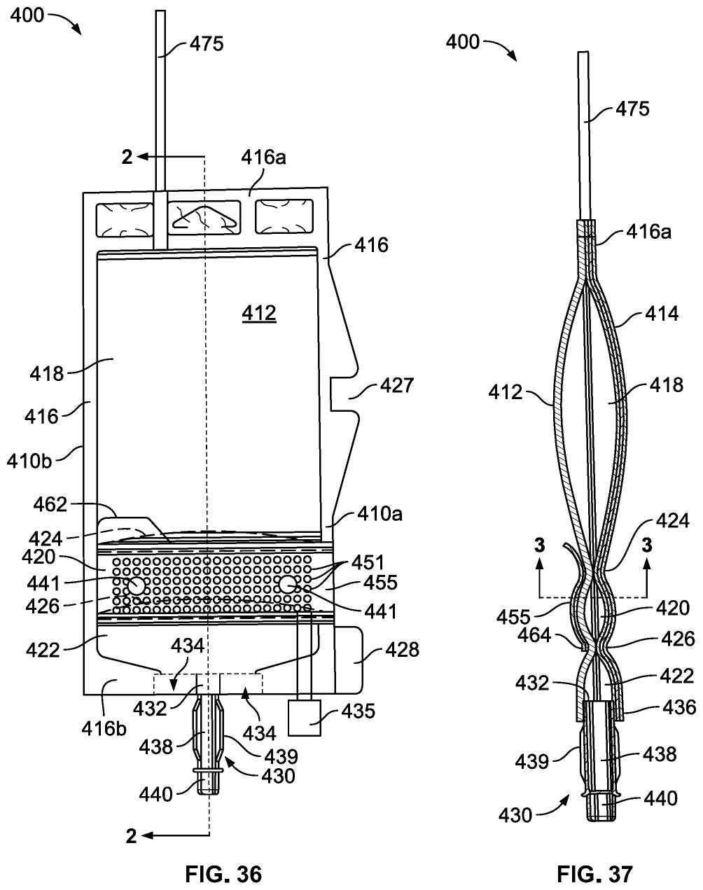

Referring to FIGS. 36 and 37, there are shown schematic front and cross-sectional side views, respectively, of an alternative embodiment of a flexible, sterile product bag 400 provided in accordance with practice of principles of the present disclosure. Although the product bag 400 can be viewed in any orientation, for purposes of explanation herein, the position of the chamber portions of the container relative to one another are described as positioned in FIGS. 36 and 37. The product bag 400 is formed from a front sheet 412 and a back or rear sheet 414 (shown only in FIG. 37). The front and back sheets 412, 414 may be constructed of a single layer of flexible material or multi-layer laminates of flexible material to be described in greater detail below. The sheets forming the container can be provided separately and then sealed together at their common peripheral edge, forming an edge perimeter seal 416 which can extend around the entire periphery of the container. Such peripheral seals may vary in configuration and width. A patterned seal, such as that depicted on the top seal portion 416a and the bottom seal portion 416b in FIG. 36 may be used to provide grasping areas for the user to handle the container and for the attachment of the container to, for example, an IV support stand. Alternatively, the front and rear sheets can be formed from a single film sheet which is subsequently folded-over and sealed by means of a heat seal which extends around the peripheral portion of the container. The sealed-together sheets are referred to herein as the “shell” or “body” of the container.

In the present embodiment, the product bag 400 includes a bladder defining a chamber 403 that is partitioned into three separate chamber portions: an upper chamber portion 418, an intermediate chamber portion 420, and a lower chamber portion 422. Each chamber portion 418, 420, 422 is sterile and, at least in one version, empty prior to use. The upper and intermediate chamber portions 418 and 420 are separated from one another by a first peelable seal 424, and the intermediate and lower chamber portions 420 and 422 are separated from one another by a second peelable seal 426. The peelable seals 424 and 426 extend between the two sides of the bag 400, i.e., between the right side 410a and the left side 410b joining the front and rear sheets. A “peelable” seal as the term is used herein with reference to FIGS. 36-44 can be the same as or different than that described above with reference to FIGS. 34-35. Regardless, such a seal is sufficiently durable to allow normal handling of the container yet which will peel, allowing separation of the front sheet from the back sheet in the region of the seal, under hydraulic pressure applied by manipulating the container, thereby allowing mixing and dispensing of the container contents. A peelable seal is formed by a partial melting together of the polymer present in the adjacent layers of the front and back sheets. The seal is obtained by a heat sealing process which is performed with varying times, temperatures, and pressures to be described in greater detail below. Conversely, the peripheral edge or perimeter seal 416 is significantly stronger than the “peelable” seals and will not be ruptured by pressures generated to separate the peelable seals. Configuration of the peelable seals with a non-linear resistance to the hydraulic opening pressure of a manipulated container, as contrasted to a conventionally formed straight-line seal, promotes substantially complete peeling of the entire seal during use of the container as will be described in greater detail subsequently.

As also seen in FIG. 36, the product bag 400 includes a filtered stem 475 at a top portion in communication with the upper chamber portion 418 and an optional vial adaptor 435 at a bottom portion in communication with the intermediate chamber portion 420. The filtered stem 475 can include a filter, filter membrane, or filtration device the same as those described above with reference to FIGS. 1-20, and the vial adaptor 435 can include a vial adaptor identical to that described above with reference to FIGS. 28-33. As such, the details of the filtered stem 475 and the vial adaptor 435 will not be repeated.

In a typical application for the product bag 400, the upper chamber portion 418 is initially supplied to the pharmacist empty and subsequently filled with a liquid diluent through the filtered stem 475. The intermediate chamber portion 420 is supplied either empty or filled with a concentrate, typically provided in powder form, but could be foam, gel, liquid, granulates, flakes, etc. In those product bags 400 where the intermediate chamber portion 420 is supplied empty to the pharmacist, the vial adaptor 435 can be used to introduce a concentrate to the intermediate chamber portion 420. The vial adaptor 435 can take different forms, but one embodiment is identical to the vial adaptor described above with reference to FIGS. 28-33. Therefore, the details will not be repeated. The lower chamber portion 422 functions as a security interface for an outlet port 430. The outlet port 430 extends downwardly from a conformal saddle 432 which, when viewed from above, is shaped like an ellipse with its focal ends flattened, and is disposed in about the center of the container's lower edge between the front sheet 412 and the rear sheet 414. The flattened focal ends of the saddle 432 form flanges 434, best seen in FIG. 36, which taper towards the flattened edges of the saddle 432. The flattened elliptical shape creates a smoothly curved surface to which the front and rear sheets are firmly attached by, for example, a permanent heat seal (termed herein the “outlet seal”) 436 (shown in FIG. 37). The outlet port 430 comprises a body portion 438 and a nozzle 440 which is configured for attachment to a standard IV administration device. A cap (not shown) is provided to cover the nozzle and maintain its sterility. The cap is removed just prior to attachment of an IV set to the outlet port. Ribs 39 are provided in spaced-apart relationship about the body portion 438 of the outlet port 430 to give a surface that may be easily grasped when attaching an IV set to the container. In the illustrated embodiment, four ribs 39 are provided which extend longitudinally from the surface of the body portion 438 of the product bag 400. While four longitudinal ribs are depicted, one having skill in the art will recognize that various other types of surface articulation may be provided that will allow the port to be easily grasped, such as circumferential ribs, transverse ribs, knurling or crosshatching of the body portion surface, and the like.

The materials employed in the front and rear sheets of the product bag 400 can be selected based on the material to be stored therein. Preferably, at least one of the sheets is transparent to allow the contents of the container to be visually inspected and to allow the level of the solution in the container to be seen during dispensing. Suitable materials for fabrication of the transparent sheet are typically single-layer and multi-layer laminated, polymer films.

In particular, whether constructed of a single layer or a multi-layer laminated polymer film, the materials comprising the front 12 and rear 14 sheets of the product bag 400 are chosen for their clarity and transparency. Conventional polyvinylchloride (PVC) container materials are generally quite murky in appearance, making it difficult to adequately view the interior of the container and determine the levels of any fluids contained therein or the presence of particulate matter. This is a particularly dangerous situation when administering medication intravenously. It is imperative that a nurse or clinical worker be able to tell, at a glance, that the fluid of any such medication being administered from a medical container is free from particulate matter.

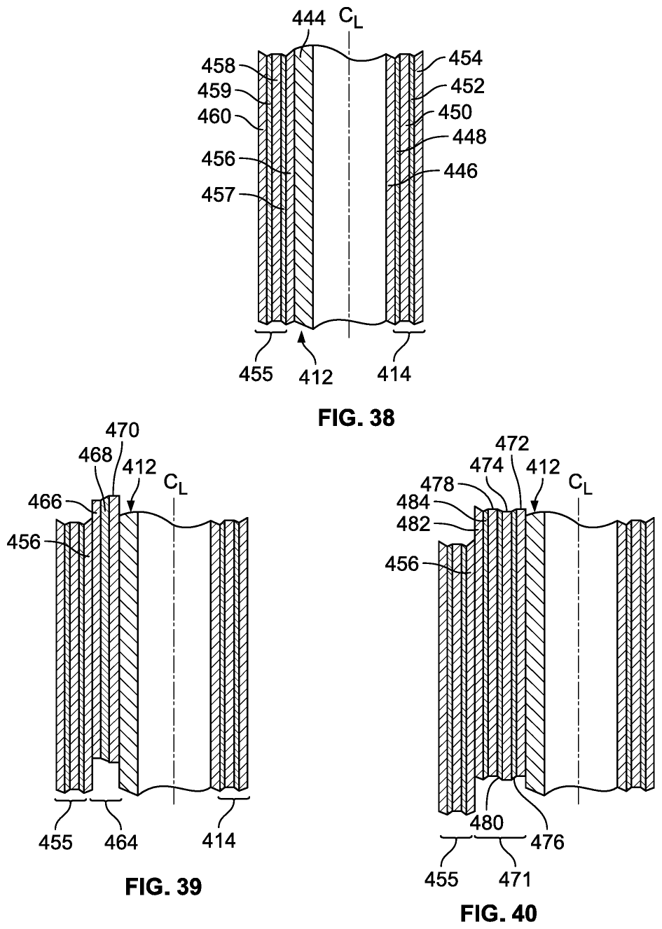

In a first version of the product bag 400, which is depicted in fragmentary schematic cross-section in FIG. 38, the front sheet 412 is constructed of a transparent, single-layer, thermoplastic polymer film 444. In this embodiment the transparent film 444 comprises a blend of about 80% by weight polypropylene-polyethylene copolymer available from Fina Oil and Chemical Company, of Deerpark, Tex., having a commercial designation of Z9450, and about 20% by weight styrene elthylene-butylene styrene thermal plastic elastomer, available from Shell Chemical Corporation under the trade name KRATON® and having a commercial designation G1652. Kraton® G1652 thermal plastic elastomer is a three block copolymer with polystyrene end blocks and a rubbery poly (ethylene-butylene) midblock. In practice, the film is made by mixing pellets of the co-polymer resin and KRATON® in crumb form in the 80%/20% by weight ratio, in a high shear mixer and melting and repelletizing the mixture. Subsequently, the transparent film 444 is formed from the blended pellets in a commercial extrusion apparatus. The transparent polymer film 444 comprising the front sheet 412 may be constructed with varying thicknesses, depending on the use to which the container is put, and the durability required for that application. Suitable thicknesses for the material comprising the front sheet 412 may range from about 3 to about 15 mils. In one preferred embodiment, the transparent polymer film 444 comprising the front sheet 412 has a thickness of 12 mils.

In addition to its clarity and transparency, the transparent polymer film 444 (which may be referred to alternatively as the “80:20 film”) is particularly suitable for forming both “peelable” seals and permanent edge seals along the periphery of the product bag 400. As will be described in greater detail below, the 80:20 film, in accordance with the invention, is able to accommodate both lower-temperature peelable seal, and higher-temperature permanent seal, formation processes without affecting the material's integrity or its ability to provide an effective peelable seal.

For certain combinations of diluents and medicaments, the rear sheet 414 can have the same single layer composition and configuration as the front sheet 412. Alternatively, multi-layer films which include layers which are impermeable to moisture and light, for example, may be preferred for the rear sheet to extend the shelf life of a filled container. In the embodiment of the container depicted in FIG. 38, a three-layer, laminate rear sheet 414 is employed which is impermeable to water vapor and to light in order to preserve the effectiveness and activity of the binary components (the unmixed medicament and diluent), thus increasing the shelf life of the filled container.

In the exemplary embodiment, the rear sheet 414 includes an inner, seal layer 446 on its inwardly facing surface, constructed of an 80%/20% wt/wt blend of polypropylene-polyethylene copolymer and styrene ethylene-butylene styrene thermal plastic elastomer having a thickness of about three to six mils (the 80:20 film). In one preferred embodiment, the inner seal 80:20 film layer 446 is a six mil thick composition, which is bonded by means of a suitable transparent adhesive 448 to an approximately 0.7 mil to 1.3 mil (preferably 1.0 mils) high-barrier aluminum foil layer 450. An outer, high melting temperature layer 454 is provided on the rear sheet's outwardly facing surface, and is bonded to the high-barrier aluminum foil layer 450 by means of a suitable transparent adhesive 452. In the embodiment of FIG. 38, the adhesive layers 448 and 452 comprise a modified aliphatic polyester polyurethane adhesive, available from Liofol Co. of Cary, N.C., under the commercial designation TYCEL 7909. The aluminum foil layer 450 is suitably constructed of a commercially available 1 mil. aluminum foil, such as Alcan 1145, available from the Alcan Rolled Products Company of Louisville, Ky.

Because the heat sealing process used to form the peripheral edge seals and the transverse peelable seals is capable of damaging the high-barrier aluminum foil layer, were that layer to remain exposed, the outer high temperature layer 454 is constructed of a relatively high-melting polymer and functions as a protective layer to prevent contact between the foil layer and the hot patterns of a heat seal apparatus. Further, the high-temperature layer 454 serves as a heat seal release (also termed mold release) because it does not melt and stick to the heat seal platens at the temperatures used to form the seals.

The outer high-temperature layer 454 is preferably a polyethylene terephthalate (designated herein as PET or polyester) available from Rhone-Poulanc under the commercial designation TERPHANE 10.21, having a thickness of in the range of about 0.4 to about 0.6 mils. In one preferred embodiment, the thickness dimensions of the multi-layer laminate film 414 are 0.48 mils for the outer, higher-temperature polyester layer 454, 1.0 mils for the high-barrier aluminum foil layer 450, and 6.0 mils for the 80:20 film inner seal layer 446.

It has been found that preferable material choices for the front and rear sheets, which result in optimum performance of the peelable seals, incorporate an interfacing seal layer on both sheets comprising the 80:20 film. However, the interfacing seal layers of the front and rear sheets may, alternatively, comprise polypropylene-polyethylene co-polymer and styrene butadiene elastomer blends having differing relative percentages. The relative percentages used will depend on the characteristics of the various seals contemplated for use in connection with a particular medical container, and the temperature and pressure parameters of the sealing process. Other types of flexible films, which may be useful in the construction of the front and rear sheets of the shell of the product bag 400 of the present invention, as well as the interfacing seal layers on both sheets, are disclosed in U.S. Pat. Nos. 4,803,102, 4,910,085, 5,176,634, and 5,462,526, all of the disclosures of which are expressly incorporated herein by reference.

In certain applications, particularly where a concentrate is prefilled in the intermediate chamber portion 420, additional protection for the second or intermediate chamber portion 420 of the product bag 400 is preferred. Such additional protection is provided to preclude moisture, oxygen and/or light transmission through the film comprising the front of the intermediate chamber portion to protect the medicament powder from degradation. Such additional protection allows the product bag 400 to be stored, for substantial periods of time, without losing medicinal efficacy.

Referring in particular to FIG. 38, an opaque, high-barrier protective film 455 is employed, in the illustrated embodiment, to cover the intermediate chamber portion 420. The film 455 interposes a barrier to moisture vapor and free oxygen permeation into the intermediate chamber portion. In the exemplary embodiment, the high-barrier protective film 455 comprises a multi-layer laminate structure including a high-barrier aluminum foil layer. The use of an opaque aluminum foil laminate further helps prevent the medicament contained in the intermediate chamber portion 420 from being degraded due to exposure to visible light and UV radiation. Thus, in the present embodiment, the opaque aluminum foil comprising both the protective film 455 and the rear sheet 414 prevents penetration of UV and visible spectrum light into the intermediate chamber portion 420 of the container.

The high-barrier protective film 455 is a multi-layer laminate, constructed of an inner seal layer 456, on its inwardly facing surface. In an exemplary embodiment, the seal layer 456 is a soft co-extrusion coated resin comprising a modified ethylenevinylacetate polymer available from the Dupont Chemical Company under the commercial designation APPEEL 1181, provided in a thickness of from about 0.2 to about 0.4 mils. An aluminum foil layer 458, such as Alcan 1145, of from about 0.7 to about 1.3 mils, (preferably about 1.0 mils) thickness is bonded to the inner seal layer 456 by means of a suitable transparent adhesive 457. An outer, heat seal release layer 460 comprising a polyethylene terephthalate (PET) film, such as TERPHANE 10.21, approximately 0.48 mils in thickness, forms the outwardly facing surface of the high-barrier protective film 455 and is bonded over the aluminum foil layer 458 by means of a suitable transparent adhesive 459. The adhesive layers 457 and 459, of the present embodiment, comprise a modified aliphatic polyester polyurethane adhesive available from Liofol Co. under the commercial designation TYCEL 7909.

Because the inner seal layer 456 of the high-barrier protective film 455 is a co-extrusion coated resin, it is able to provide a peelable seal, over a broad temperature range, when applied to a number of different materials. Materials to which such a co-extrusion coated resin forms a peelable seal include acrylonitrile-butadiene-styrene (ABS), high density polyethylene (HDPE), high impact polystyrene (HIPS), polypropylene (PP), polystyrene (PS), polyvinylchloride (PVC), and the 80:20 film comprising the front sheet 412. The high-barrier protective film 455 may, thus, be removably (peelably) affixed to the outer surface of the front sheet 412, covering the intermediate chamber portion 420.

Preferably, the high-barrier protective film 455 is removable (peelable) from the container prior to its use, to allow examination of the state of the concentrate in the interior of the intermediate chamber portion 420. In the exemplary embodiment, best seen in connection with FIG. 36, the protective film 455 includes an extending tab 462 which may be grasped in order to peel the protective film 455 away from the transparent front sheet 412. The contents of the intermediate chamber portion 420 are thereby exposed and can be visually inspected.

As can be understood by referring to FIG. 36, the high-barrier protective film 455 is not affixed to the container by a seal over its entire surface area; rather, the film 455 is only partially sealed to the underlying material. Those portions of the high-barrier protective film 455 which are not sealed define a regular array of generally circular raised dimples 451, which are the tactile residue of a heat seal bar into which a rectangular array of holes has been cut. When the heat seal bar is pressed over the surface of the high-barrier protective film 455, a heat seal is provided only on the surface contact regions of the heat seal bar and not in the regions where the bar material has been removed (the holes). Since pressure is also applied along with heat, during the process, the high-barrier protective film 455 takes an impression from the heat seal head, thus giving rise to the textured, raised dimpled surface.

The dimples 451 allow the high-barrier protective film 455 to be adequately sealed over the underlying material of the medical container but, at the same time, provide for easy removal of the film 455 without the application of undue force. Were the entire protective layer 455 to be heat sealed onto the surface of the container, a larger than desired amount of force would be required to completely peel it away. By reducing the surface area of the seal, a lesser force (proportional to the seal area) is required to remove the peelable aluminum strip. It is apparent from the foregoing description, that the amount of force required to remove the peelable aluminum strip is inversely proportional to the number of dimples (451 of FIG. 36) formed in the film 455. Depending on the use to which the medical container is put, a more or less easily removable high-barrier protective layer may be easily constructed by merely increasing or decreasing the number of dimples 451 formed in the layer during the heat seal process.

In practical use, the filled bag is received by a hospital's pharmacy services, and first or upper chamber portion 418 is entirely empty and sterile. The intermediate chamber portion 420 is either empty and sterile or prefilled with a concentrate and sterile. The bag 400 can then be stored for a period of time against need. Typically, prior to dispensing, the pharmacist first fills the upper chamber portion 418 with a diluent through the sterilization filtered stem 475 to provide sterile diluent to the upper chamber portion 418. Then, if needed, the pharmacist introduces concentrate to the intermediate chamber portion 420 through the vial adaptor. Then, in some cases, the pharmacist removes the high-barrier foil layer 455 from the surface of the bag 400, thus exposing the intermediate chamber portion 420 in order visually inspect the integrity of the contents. If the bag 400 is not put into use at that time, it is returned to the pharmacy and dispensed again, at the next request. The removal of the peelable high-barrier film 455 from the intermediate chamber portion 420 leaves the contents of the intermediate chamber portion 420 susceptible to degradation by moisture, light and permeable oxygen. It is desirable that the filled containers, of the present invention, are able to be stored in pharmacy services for periods of time up to 30 days, prior to use, without the concentrate being severely degraded by exposure to moisture and free oxygen after the high-barrier protective film over the intermediate chamber portion 420 has been removed. Accordingly, as is shown in FIG. 39, in one embodiment of the present invention, a transparent high-barrier intermediate laminate film 464 is optionally interposed between the high-barrier aluminum foil-containing protective film 455 and the intermediate chamber portion 420. The transparent high-barrier intermediate film 464 covers and protects the contents of the intermediate chamber portion 420, after the peelable protective film 455 is removed from the product bag 400, from at least moisture vapor and free oxygen permeation for a substantial period which, depending on the activity of the contents of the intermediate chamber portion 420, may be as long as 30 days. In other words, the opaque, high-barrier protective film 455 in combination with the transparent, high-barrier intermediate film 464 forms a high-barrier protective e covering over the intermediate chamber portion 420.

Polymers are classified by the degree to which they restrict passage of penetrant gasses, e.g., oxygen or moisture vapor. The categories range from high-barrier (low permeability) to low-barrier (high permeability). The category in which a polymer is classified may vary according to the penetrant gas. As used herein, the term “high barrier”, when it refers to moisture vapor permeability, means a film with a permeability of less than about 1.5 g/mil/m2/ 24 hr/atm, at 38° C., 100% R.H. As used herein, the term “high barrier” when it refers to oxygen permeability means a film with a permeability of less than about 50 cc/mil/m2/24 hr/atm, at 25° C., 100% R.H.

In one exemplary embodiment, the transparent high-barrier intermediate film 464 comprises a three-layer high-barrier laminate structure which is significantly resistant to free oxygen and water vapor permeability so as to protect the contents of the intermediate chamber portion and increase shelf life of the binary container. In one embodiment, the intermediate film 464 includes an outer layer 66 of silica deposited polyethylene terephthalate (also termed SiOx coated polyester or SiOx coated PET), available from Mitsubishi Kasei under the commercial designation TECH BARRIER™ H, in contact with the sealant layer 456 of the high-barrier protective film 455. The outer layer 66 is bonded to an intermediate layer 68 comprising a silica deposited (SiOx coated) polyvinyl alcohol (PVA) film available from Mitsubishi Kasei under the commercial designation TECH BARRIER™ S. On its inwardly facing surface, the transparent, high-barrier intermediate film 464 includes an inner seal layer 470 comprising a polypropylene-polyethylene co-polymer, which may be blended with styrene ethylene-butylene styrene thermal plastic elastomer in various ratios. However, a 100% polypropylene-polyethylene co-polymer layer is preferred. The individual layers of the intermediate laminate film 464 are adhesively bonded to one another. For clarity, however, these adhesive layers are not shown but comprise a modified aliphatic polyester polyurethane laminate available from Liofol Co. under the commercial designation TYCEL 7909. The inner seal layer 470 is securely affixed to the outer surface of the container front sheet 412 by an appropriate permanent heat or ultrasonic seal, an adhesive pressure seal, or the like. The transparent, high-barrier intermediate laminate film 464 is sized, horizontally and vertically, to cover the entire surface area of the intermediate chamber portion and also extends to cover the peelable and permanent seals formed adjacent the intermediate chamber portion.

As is the case with the flexible, plastic materials which comprise the front sheet 412 of the product bag 400, the three-layer laminate structure of the intermediate layer 464 is substantially transparent to allow inspection of the contents of the intermediate chamber portion 420. Thus, unlike polyvinylchloride (PVC), and other similar materials, which are fairly hazy (translucent), the intermediate layer 464 is substantially clear and transparent, allowing the contents of the intermediate chamber portion 420 to be easily inspected, while imparting considerable protection against moisture and free oxygen degradation.

In particular, the barrier properties of the transparent, high-barrier intermediate laminate film 464 are substantially greater than those of conventional films, such as low-density polyethylene (LDPE), medium-density polyethylene (MDPE), linear low-density polyethylene (LLDPE), ethylene-vinyl acetate copolymers (EVA), or blends of these polymers, in areas important to the function of the container, e.g., moisture and oxygen permeability. The oxygen permeability of the intermediate layer 464 is approximately 10 cc/mil/m2-24 hr/atm. Conversely, the oxygen permeability of EVA copolymers, LDPE and MDPE, respectively, are approximately 2500 (EVA 5%), 8300 (LDPE), and 8500 (MDPE) cc/mil/m2-24 hr/atm. The oxygen permeability of LLDPE is approximately the same or slightly higher than LDPE. Thus, the oxygen permeability of the transparent, high-barrier intermediate layer 464 is orders of magnitude less than the oxygen permeability of polymers typically used to construct binary medical containers.

Because of the intermediate laminate film's barrier properties, the peelable aluminum foil-containing protective film 455 may be removed by a pharmacist in order to perform an inspection on the bag's contents prior to dispensing, and the container may then be stored for an additional period of time without the danger of oxygen or moisture induced medicament degradation. Once the protective foil layer is removed, it is desirable that the bag have a storage shelf life of about 30 days. After removal of the aluminum foil layer, the precise shelf life of a container which includes a clear high barrier laminate film 464 depends necessarily on the moisture sensitivity of the drug contained in the intermediate chamber portion 420. Drugs with a relatively low moisture sensitivity are able to retain efficacy for periods substantially longer than days by virtue of being protected by the clear high barrier laminate film 464. In addition, drugs with an extreme moisture sensitivity, i.e., those that would normally begin to loose effectiveness almost immediately upon removal of the aluminum foil layer, may be stored for periods up to two weeks without loosing effectiveness because of the moisture barrier properties of the clear high barrier film overlying the intermediate chamber portion 420.

Although the intermediate barrier film 464 has been described in the exemplary embodiment as being affixed to the outer surface of the intermediate chamber portion 420, it will be apparent to one skilled in the art that the intermediate layer may be sized to cover both the intermediate chamber portion 420 and the upper chamber portion 418 if desired. The manner of attachment of the intermediate layer to the outer surface of the bag 400 may also be varied. The intermediate layer 464 may be permanently secured to the outer surface of the bag 400 by a suitable adhesive, as well as by permanent heat or ultrasonic sealing. Alternatively, the intermediate film 464 may be removably provided on the surface of the bag 400 by adjusting the temperature and pressure characteristics of a heat seal, in order to make the seal peelable. In this case the film 464 could be peeled from the product bag 400 as was the case with film 455.

It should be noted that in the exemplary embodiment, the medicament is disclosed as being in the form of a dry powder, granulate, flake, gel, foam, or other form. Such forms can be for example, antibiotic compositions or antiemetic compositions, with non-limiting examples of such being; cefazolin, cefuroxime, cefotaxime, cefoxitin, ampicillin, nafcillin, erythromycin, ceftriaxone, metoclopramide and ticar/clay. However, a liquid concentrate may also be employed in this system. Such a condition may arise when a liquid concentrate and a liquid diluent are not compatible for long periods of time and must be mixed just prior to being dispensed to a patient. Also, the concentrate may be in the form of a colloid, crystalloid, liquid concentrate, emulsion, or the like. In addition, the intermediate chamber portion 420 need not be filled with a drug, per se. Other medical compositions, such as lyophilized blood fractions, blood factor 8, factor 9, prothrombin complex, and the like, are equally suitable. While a single medicament, and a single upper chamber portion 418 is disclosed in the bag, bags which have multiple chamber portions filled with different diluents and/or different concentrates, may be provided in accordance with the present invention.

In a second version of the product bag 400, which is depicted in schematic cross-section in FIG. 40, an alternative construction is provided for the transparent, high-barrier, intermediate laminate film (464 of FIG. 39), which covers the intermediate chamber portion.

As was the case with the first version, depicted in FIGS. 37-39, the clear high-barrier intermediate laminate film 471 of FIG. 40, may be provided in combination with an opaque, high-barrier, aluminum foil-containing protective film (455 of FIGS. 37-38) disposed over the intermediate film 471 and, thus, also over the intermediate chamber portion 420 of the bag 400. Accordingly, the clear, high-barrier intermediate film 471 in combination with an opaque, high-barrier protective film, comprises a high barrier protective covering disposed over the intermediate chamber portion 420. As will be described in greater detail below, the high barrier protective covering may include either a high moisture barrier layer, a high oxygen barrier layer, or both. The opaque aluminum foil-containing protective film 455 is provided to prevent penetration of UV and visible spectrum light into the intermediate chamber portion 420 of the bag 400, if such protection is desired.

The alternative high-barrier intermediate laminate film is constructed of a transparent, multi-layer thermoplastic polymer laminate, indicated generally at 471, with high moisture and oxygen barrier properties. In the exemplary embodiment of FIG. 40, the transparent, multi-layer, high-barrier film 471 comprises a sealant layer 472 on its inward facing surface, constructed of 100% polypropylene having a thickness of about 3.0 mils. An oxygen barrier layer 474 is laminated to the sealant layer 472 by a first bond layer 76 comprising a commercially available low density polyethylene (LDPE) extrudate in combination with a primer, and which is interposed between the oxygen barrier layer 474 and the sealant layer 472. Several flexible, polymer films have been determined to be able to provide suitable barriers to oxygen permeability, as will be described further below, but preferably, the oxygen barrier layer 474 of the multi-layer high-barrier film 471 is constructed from a commercially available ethylenevinylalcohol (EVOH) having a thickness of about 0.55 mils.

Ethylenevinylalcohol is primarily noted for its barrier properties against oxygen permeability. In particular, its oxygen permeability barrier values are typically in excess of four orders of magnitude greater than conventional primary bag films such as ethylenevinylacetate (EVA), SURLYN®, medium and high-density polyethylene (MDPE, HDPE). However, while affording a considerable barrier to oxygen permeability, ethylenevinylalcohol, alone, may not provide sufficient protection from water vapor. Accordingly, a moisture barrier layer 478 is laminated to the ethylenevinylalcohol oxygen barrier layer 474 by a second low density polyethylene (LDPE) bonding layer 80. Moisture barrier 78 is a transparent, flexible film comprising an oriented high density polyethylene (OHDPE) polymer available from the Tredegar Co. of Richmond, Va. under the commercial designation of MONAX™, grade HD. The resultant composite barrier structure includes a polyester (PET) heat seal release layer 82 (such as TERPHANE 10.21) on its outward facing surface, and which is laminated, in turn, to the moisture barrier 78 by a third low density polyethylene extrudate bonding layer 84.

The multi-layer, high-barrier polymeric laminate film 471 of the exemplary embodiment described in connection with FIG. 40 is a high oxygen barrier and moisture impermeable flexible film that is suitable for constructing the intermediate layer (464 of FIG. 39) covering the intermediate chamber portion (420 of FIG. 36) of a product bag 400. All of the materials comprising the laminate are substantially clear and transparent, and do not show any substantial coloration. Thus, the composite film of the illustrated embodiment of FIG. 40 is particularly suitable for covering the intermediate chamber portion 420 of a product bag 400 such that its contents may be readily inspected at a glance.

A higher transparency is obtainable for the multi-layer laminate film 471 of FIG. 40 as opposed to the SiOx containing laminate film 464 of FIG. 39. In particular, while transparent, the SiOx containing film exhibits a slight yellowish color, the absence of which in the multi-layer laminate film 471 is thought to be the primary reason for the laminate film's higher transparency.

In addition, SiOx containing material is relatively rigid and brittle, and can be cracked during the primary container manufacturing, filling, and/or handling process. Because of its inherent rigidity, the barrier properties of a SiOx containing film decrease if the SiOx film is stretched beyond 1% due to destruction of the SiOx film substrate. In addition, the state of SiOx coating technology is such that a SiOx film's barrier properties will vary from point-to-point over the surface of the film. This is because currently available SiOx sputtering processes are not able to form a smooth film of consistent thickness. This variability of barrier properties is typically greater than that shown by extruded polymeric materials, which have a lower variance because of their inherent homogenous character. The barrier properties of a homogenous polymeric barrier film is primarily a function of film thickness, which can be controlled very precisely during the manufacturing process.

While preferred materials for the clear, high-barrier intermediate film would include both an oxygen barrier layer and a moisture barrier layer, alternate materials may be used to provide a intermediate chamber portion cover which is adapted for particular uses. For example, one of the high barrier layers may be omitted giving a high-barrier intermediate film which includes only a moisture barrier layer, or only an oxygen barrier layer. Moreover, the high-barrier intermediate film may include a moisture barrier layer, as described above, in combination with a heat seal release layer which is constructed from a high melting temperature material which also has oxygen barrier properties.

Table 1 is a non-limiting list showing the exemplary film 471 of FIG. 5 and four additional examples of multi-layer films or laminates useful in the fabrication of various embodiments of a clear, high-barrier, intermediate layer according to the invention. In the list, oHDPE refers to an oriented high-density polyethylene such as HD grade MONAX, polyvinylidene chloride coated PET refers to a product available from DuPont Chemical Co. under the commercial designation 50M44, and ACLAR™ refers to polychlorotrifluoroethylene film available from Allied Signal Corporation and which is also known under the commercial designation ULTRX 2000.

TABLE 1

| | Thickness, | |
|---|---|---|
| Material of Laminate Layer 71 | mil | Layer Description |
| 1. | | |
| PET (outside layer) | 0.48 | Heat Seal Release |
| LDPE Extrudate | 0.5-1 | Bond Layer |
| oHDPE | 2 | Moisture Barrier |
| LDPE | 0.5-1 | Bond Layer |
| EVOH | .55 | Oxygen Barrier |
| LDPE Extrudate/Primer | 0.5-1 | Bond Layer |
| Polypropylene (100%) (inside layer) | 3 | Sealant layer |
| 2. | | |
| PET | 0.50 | Float Scat Release |
| Adhesive | | Bond Layer |
| oHDPE | 2 | Moisture Barrier |
| Adhesive | | Bond Layer |
| Polypropylene (100%) | 3 | Sealant Layer |
| 3. | | |
| Polyvinylidene Chloride Coated PET | 0.50 | Heal Seal Release and |
| | | Oxygen Barrier |
| Adhesive | | Bond Layer |
| oHDPE | 2 | Moisture Barrier |
| Adhesive | | Bond Layer |
| Polypropylene (100%) | 3 | Sealant Layer |
| 4. | | |
| PET | 0.48 | Float Seal Release |
| Adhesive | | Bond Layer |
| Aclar ™ | 2 | Moisture Barrier |
| Adhesive | | Bond Layer |
| EVOH | .55 | Oxygen Barrier |
| Adhesive | | Bond Layer |
| Polypropylene (100%) | 3 | Sealant Layer |
| 5. | | |
| Polyvinylidene Chloride Coated PET | 0.50 | Heal Seal Release and |
| | | Oxygen Barrier |
| Adhesive | | Bond Layer |
| Aclar ™ | 2 | Moisture Barrier |
| Adhesive | | Bond Layer |
| Polypropylene (100%) | 3 | Sealant Layer |

In accordance with practice of the present invention, each of the multi-layer laminate films discussed above, are contemplated as forming a clear high-barrier covering over the intermediate chamber portion 420 of the sterile product bag 400. Preferably, the rear sheet 414 of each such container is constructed of a multi-layer laminate structure including a high moisture barrier aluminum foil-containing film, comprising the 80%/20% wt/wt film on its inwardly facing surface, as described in connection with the embodiment of FIG. 38.

Constructing the rear sheet 414 of the bag 400 from an opaque aluminum foil-containing high-barrier laminate film allows the contents of the bag 400 to be protected from exposure from UV and visible spectrum light which may degrade its contents. In practical use, the peelable aluminum foil-containing film, covering the intermediate chamber portion 420, is typically removed prior to dispensing by a hospital's pharmacy. Since the high-barrier intermediate films are clear, they do not provide protection against light exposure and care must be taken to prevent the contents of the intermediate chamber portion 420 from being inadvertently exposed to UV or intense visible spectrum light during subsequent container storage. Accordingly, the bag 400 is folded-over upon itself in the region of one of the peelable seals, such that the aluminum foil-containing film (or rear sheet) forms the outward facing surface of the folded-over container and helps protect the contents of the intermediate chamber portion 420 from exposure to UV or intense visible spectrum light.

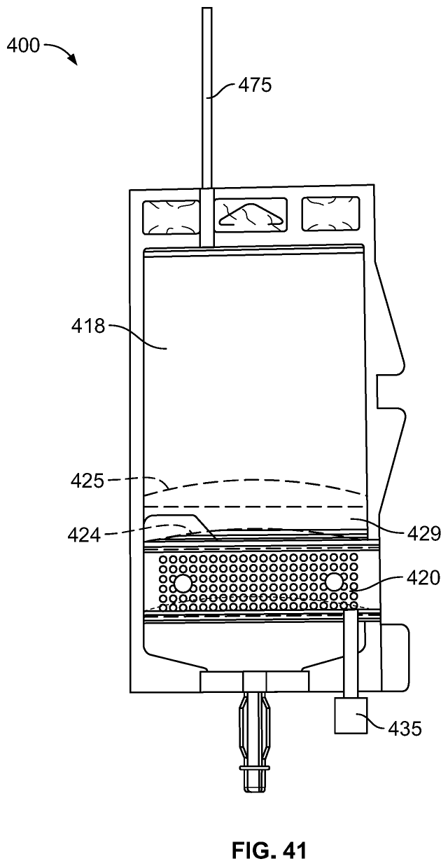

Referring to FIG. 41, in a modified version of the bag 400, additional protection is provided to the intermediate chamber portion 420 by providing a sacrificial moisture vapor permeation path for moisture vapor which may be developed in the liquid-containing upper chamber portion 418. The sacrificial moisture vapor permeation path is provided by forming an additional peelable seal 425 across the bag 400 a short distance in advance of, or above, the peelable seal 424 which separates the intermediate chamber portion 420 from the upper 418 chamber portion. The additional peelable seal 425 is preferably disposed about ⅛ to ½ inch above the peelable seal 424, i.e. in the direction of the upper chamber portion 418. The first peelable seal 424 and the additional peelable seal 425, together define a buffer chamber portion 429, disposed between the upper chamber portion 418 and the intermediate chamber portion 420. The buffer chamber portion 429 is preferably empty.

When the product bag 400 is constructed with the additional peelable seal 425 and buffer chamber portion 429, a sacrificial moisture vapor permeation path is provided which protects powdered drugs in the intermediate chamber portion 420 from moisture permeating through the container material from the upper chamber portion 418. Although the intermediate chamber portion 420 is covered by one of a variety of high-barrier protective coverings, as described above, a path exists, for moisture to migrate from the upper chamber portion 418 to the intermediate chamber portion 420, through the primary container materials comprising the first peelable seal 424. In the embodiment of the invention depicted in FIG. 41, moisture vapor which may permeate through the primary container materials in the region of the additional peelable seal 425, from the upper chamber portion 418 is trapped within the buffer chamber portion 429. Since the surface area of the buffer chamber portion 429 available for vapor permeation is much larger than the permeation surface provided by the peelable seal 424, moisture vapor in the buffer chamber portion will preferentially escape into the atmosphere, rather than migrate through the material of the first peelable seal 424 and into the intermediate chamber portion 420.

Thus, it can be seen that the additional peelable seal 425 and buffer chamber portion 429 provides means for protecting the dry medicament in the intermediate chamber portion 420 from being degraded by moisture.

As mentioned, the triple chambered product bag 400 will be received by health care personnel, typically a hospital's pharmacy department, in the completed configuration shown in FIGS. 36-37. Then, use of the bag 400 is substantially similar to that described above with respect to FIGS. 34 and 35, with the exception that manipulation of the product bag 400 must also be relied upon to break the second peel seal 426 between the intermediate chamber portion 420 and the lower chamber portion 422 in order to flow the mixed solution to the outlet port 430 for patient administration. Specifically, as with the product bag 300 described above with respect to FIGS. 34 and 35, the product bag 400 can arrive at a pharmacy entirely empty or with a concentrate pre-filled in the intermediate chamber 420. In either event, the pharmacist must at least introduce diluent to the upper chamber portion 418 prior to mixing. Subsequent to introducing the diluent, the filtered stem 475 is sealed and cut, and finally integrity tested in any manner such as those discussed herein prior to proceeding. And, in those cases where the entire bag 400 is empty, the pharmacist must also introduce a concentrate to the intermediate chamber portion 420 through the vial adaptor in the manner described above.

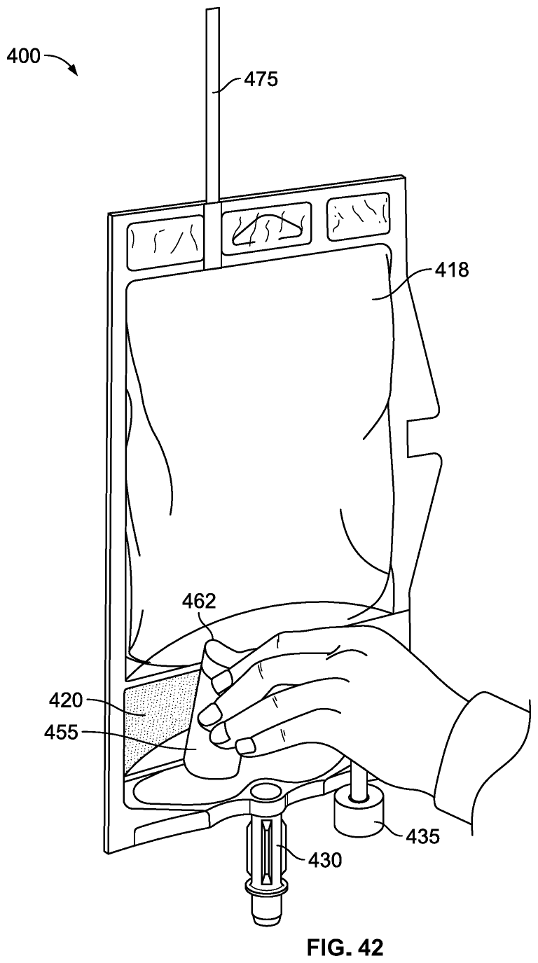

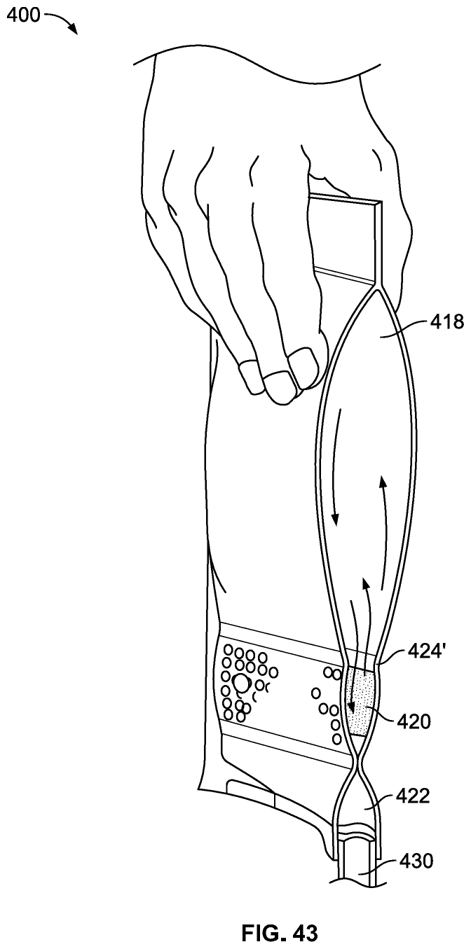

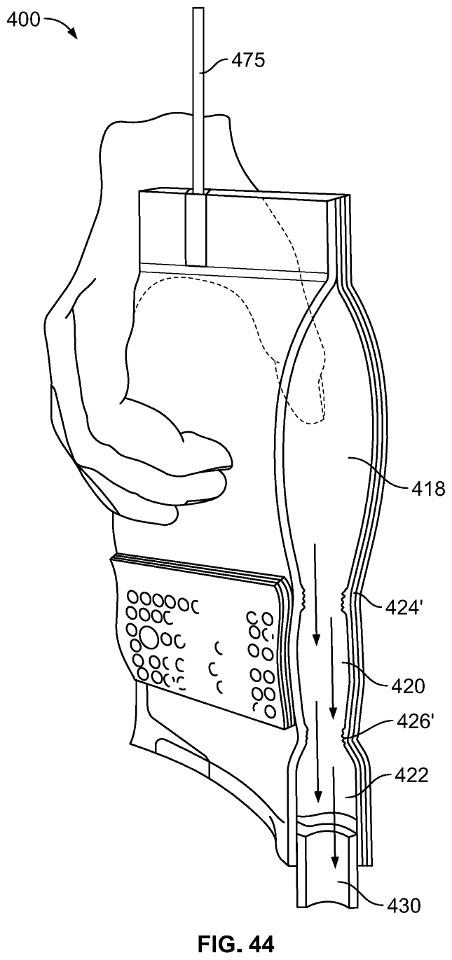

Referring now to FIG. 42, once a concentrate is resident in the intermediate chamber portion 420, in preparing to use the product bag 400, the concentrate may be inspected by grasping the tab 662 on the aluminum foil-containing protective layer 455 and peeling the protective layer from the bag 400 to enable visual inspection of the intermediate chamber portion 420 containing the concentrate. If the concentrate appears in a normal condition, the solution can be mixed as shown in FIG. 43 by manipulating the product bag 400 to compress the front and rear sheets in the area of the upper chamber portion 418. Mechanical pressure from the hydraulic forces created by manipulation of the bag 400 ruptures the peelable seal between the diluent and intermediate chamber portions (shown in the ruptured condition as 424′). Further manipulation by shaking causes mixing of the liquid diluent and powdered medicament. Verification that complete mixing is obtained is made by visually observing the mixed solution through the clear, transparent front sheet. After mixing is complete, the peelable seal between the intermediate chamber portion 420 and the lower security chamber portion 422 is broken as shown in FIG. 44 by again compressing the front and rear sheets of the container creating hydraulic pressure in the product bag 400 to rupture the seal (shown in the ruptured condition as 426′). The mixed solution is then dispensed from the bag 400 through the outlet port 430 using a standard IV delivery device.

The arrangement of the product bag 400 precludes delivery of unmixed diluent through the outlet port 430. Further, the arrangement of the intermediate chamber portion 420 between the upper chamber portion 418 and the outlet port 430 enhances the probability of complete mixing and delivery of the medicament to the patient. For bags including a liquid diluent and powdered concentrate, rupture of the first peelable seal between the upper chamber portion 418 and intermediate chamber portion 420 is essentially assured prior to rupture of the second peelable seal between the intermediate chamber portion 420 and the lower security chamber portion 422 since the hydraulic forces developed in the diluent by manipulating the bag 400 cannot be transmitted through the powder in the intermediate chamber portion 420 until the first seal has been ruptured and mixing of the diluent and concentrate has commenced. For those cases where a liquid medicament may be used, the relative size difference between the upper chamber portion 418 and the intermediate chamber portion 420 and the placement of the smaller intermediate chamber portion 420 intermediate the larger upper chamber portion 418 and the lower or security chamber portion 422 assures development of hydraulic forces which will rupture the first seal between the upper and intermediate chamber portions 418, 420 before rupture of the second seal leading to the security chamber portion 422 with only minimal care.

In the exemplary embodiments of the container, shown in FIGS. 42-44, the peelable seals are depicted as having a conventional, rectangular, shape such as the seals described in U.S. Pat. No. 5,176,634 to Smith et al. the disclosure of which is expressly incorporated herein by reference. In accordance with practice of principles of the invention, the seals, although conventionally shaped, are formed in the manner described above to provide a uniform, predictable response to manipulation pressure and peel open at an applied force of about 4.0±1.0 psi. In an additional embodiment of the invention, curvalinear peelable seals are s provided which function to peel open completely, along their lengths, under hydraulic pressure, and which are formed in substantially the same manner as the uniform peelable seals described above.

Throughout the foregoing disclosure, the various product bags 100, 150, 300, 400 have been described as optionally including a vial adaptor 120, 325, 435 for facilitating the introduction of product concentrate into the bag for reconstitution. Other embodiments of the various product bags 100, 150, 300, 400 can also include other types of ports in addition to or as a substitute for the illustrated port. Such other types of ports may include a Luer-Activate-Device (LAD) (also commonly be referred to as a Luer-Activated-Valve (LAV)) attached to the bag and in fluid communication with the bladder to provide multiple resealable connections to the interior of the bladder. The LAD could be used to introduce medical fluids such as a product concentrate to the bag similar to the vial adaptor described above. For example this LAD could be included instead of a vial adaptor, or in addition to a vial adaptor. In one version of the disclosure where the product bag includes a LAD, the LAD can also be used to not only provide a resealable connection to the interior of the bag for adding substances to the bag but also provide a resealable connection to the interior to selectively withdraw multiple distinct doses from the bag, after the bag has been filled with a medical fluid such as a medicament or nutritional substance. The LAD can also be used as an embodiment of an administration port 118 (FIG. 1).

Furthermore, while the foregoing disclosure only specifically describes embodiments of product bags with one filter arrangement disposed, for example, in line with a stem as described with reference to FIGS. 1-20, other embodiments of product bags constructed in accordance with the present disclosure can include a plurality of separate filters in communication with the chamber of the product bag. For example, in one alternative embodiment, the product bag 150 in FIGS. 3 and 4 can include two or more stems 156 communicating with the chamber 153, each stem containing a separate in-line filter 155. So configured, it may be possible to mix or combine a plurality of medical fluids or ingredients in the product bag by introducing those fluids or ingredients through the plurality of filters 155, either simultaneously or in sequence. Having a plurality of distinct filters 155 may also be beneficial for increasing the rate of filling a product bag with a single medical by simply introducing fluid through two filters simultaneously as opposed to being limited to only a single filter or where two of the ingredients are not compatible in concentrated form but are compatible once diluted. Having separate distinct stems removes the opportunity for contact in the concentrated forms. Moreover, the addition of two fluids through distinct stems reduces the need for the addition of the two fluids to be close in time. Because the medications are sterile filtered after the point of connection to the stem, the addition steps may not need to be performed within a hood or other asceptic environment. Such an arrangement may also be beneficial in specific versions where any one of the product bags 100, 150, 300, 400 described herein is further equipped with a LAD, as mentioned above. That is, in some versions, the product bag equipped with a LAD can be filled with a compounded or reconstituted medicament or fluid through the filter(s) and a pharmacist, for example, may withdraw a plurality of doses of the same medicament or fluid for different patients, where those doses may or may not be different for each patient.

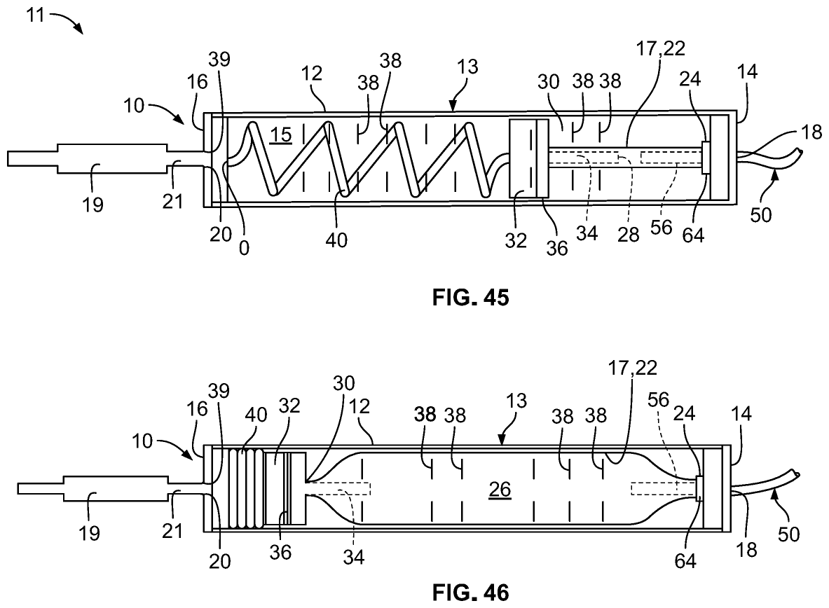

Further still, the product bag of the present disclosure has thus far been described as being a traditional parenteral solution container (e.g., an IV bag) but the product bag may include other solution containers for other purposes. For example, FIGS. 45 and 46 depict yet another embodiment of the present disclosure including a product container 11 having a filter 19 connected to and used for filling a product bag 17, which in this embodiment includes an expandable bladder or reservoir 22 of an ambulatory pump 10.

More specifically, FIGS. 45 and 46 show an embodiment of the ambulatory pump 10 including a shell 13 having a main body portion or housing 12 and first and second end caps 14, 16, respectively, attached to the housing 12. The shell 13 defines an interior chamber 15. Preferably the housing 12 is formed of a transparent or translucent plastic material. Each of the first and second end caps 14, 16 includes a port 18, 20, respectively. The expandable bladder or reservoir 22 is positioned within the chamber 15, and is fixedly connected to one of the end caps 18 at a fixed end 24. The expandable bladder 22 includes an interior storage volume 26 that in an example embodiment, in the unexpanded state or condition (as illustrated in FIG. 45), essentially defines a lumen as indicated at 28. The lumen 28 or interior storage volume 26 is in flow communication with the port 18 on the end cap 14 to which the bladder 22 is fixedly connected. For purposes of the present description, this will be referred to as the first end cap 14. Conversely, the opposing cap will be referred to as the second end cap 16.

The free end 30 of the bladder 22 is mounted to a “floating” or movable element 32, such as the illustrated connecting or indicating member or indicator. The “floating” element 32 includes a port 34 to which the expandable bladder 22 is connected and with which the lumen 28 or storage volume 26 is in flow communication. As illustrated, the element 32 can include indicia 36 to, in cooperation with indicia 38 on the housing 12, permit determining the volume of liquid L in the pump 10.

At least a portion or section of flexible tubing 40 extends between the indicating member 32 and an opening O formed by the tubing 40 for filling the bladder 22. Preferably, the opening O is in flow communication with an inlet 39 formed by the second end cap port 20. Most preferably, the flexible tubing 40 is in flow communication with both the port 34 through the indicating member 32 and the port 20 in the second end cap 16.

In this arrangement, an essentially isolated fluid storage and transport circuit is established from the second end cap 16 through the port 20 into the flexible tubing 40, through the indicator 32 and bladder 22, and out of the port 18 in the first end cap 14. The tube 40 has a relatively small inside diameter to minimize the amount of residual fluid that may be in the pump system after infusion. The small diameter tube also reduces or minimizes the time necessary for priming the pump 10. However, as will be discussed in more detail herein, the minimal amount of air (about 0.50 ml) in the tubing 40 enhances operation of the pump 10.

As will be apparent from FIGS. 45 and 46, the flexible tubing 40 permits expansion and contraction of the bladder 22. In a preferred embodiment, the tubing 40 coils onto itself (as seen in FIG. 46) as the bladder 22 expands. This results in a minimum amount of space occupied by the tubing 40 when the bladder 22 is fully expanded. Additionally, coiling of the tubing 40 reduces or eliminates the opportunity for the tubing to “pinch” as it moves within the housing 12 as the bladder 22 expands.

In a present embodiment, a tube set 50 is connected to the pump 10, which tube set 50 is configured to provide fluid, directly or indirectly from the bladder 22 to a patient. The patient delivery tube set 50 can be connected to the end cap 14 of the pump 10. Preferably the tube set 50 is connected to (e.g., formed as a part of) the pump 10 assembly.

For purposes of the present discussion, the second end cap port 20 will be referred to as the inlet or fill port 20 and the first cap port 18 will be referred to as the outlet port. The pump 10 can include at least one valve associated with the indicating member 32, the valve being configured to permit fluid L to flow into the bladder 22 from the inlet port 20 to fill the bladder 22. In a present configuration, a “duck bill” valve can be formed as part of, or mounted to, the indicating member 32, extending into the bladder 22. The duck bill valve permits fluid L input to the bladder 22 from the inlet port 20 and prevents reverse flow out of the bladder 22 through the inlet port 20.

The pump 10 further includes an outlet nozzle 56 that extends inwardly from the first end cap 14 at the port 18, into the bladder 22. In this configuration, the bladder 22 can be sealingly mounted to the port 34 and to the nozzle 56 to isolate the fluid path, and to prevent leakage from around the bladder 22 connections into the housing 12. The outlet nozzle 56 can be configured to filter flow from the bladder 22. Alternately, and preferably, the outlet nozzle 56 is configured to provide a free flow of fluid that can be regulated by a downstream restrictor device 52.

The inlet port 20 on the second end cap 20 is attached to the filter 19 via a hollow tube, which can be referred to as a portion of a stem 21. The filter 19 can include any of the filter arrangements described above with respect to FIGS. 1-20. Also, preferably, the opposite end of the filter 19 includes a portion of the stem 21 terminating at an inlet 24 preferably closed with a knob 138, a septum or membrane 151, or a seal 101, as described with respect to any of FIGS. 1-4, 21-22, and 23-27, to protect the port 20 connection, assure structural integrity of the pump 10, and reduce the opportunity for contamination of the pump 10 and liquid L. Advantageously, the product bag or bladder 22 of the presently disclosed ambulatory pump 10 can easily be filled with a sterile solution through the filter 19, same as any of the product bags described above in earlier embodiments. That is, after the inlet 24 of the stem 21 is opened, a filling nozzle can be introduced to the inlet 24 to pass a medical fluid through the filter 19 and ultimately into the bladder 22.

That is, referring specifically to FIG. 46, as the bladder 22 is filled, it expands. The force from the expanding bladder 22 on the indicator 32 moves the indicator 32 toward the inlet port 20. As the indicator 32 moves toward the inlet port 20, the flexible tubing 40 will coil to accommodate the expanding bladder 22. When the desired amount of fluid is input to the bladder 22, the portion of the stem 21 disposed between the filter 19 and the port 20 can be sealed and cut in a manner identical to the previous embodiments such that the filter 19 can be removed and integrity tested. In an embodiment, the bladder 22 is formed of an elastomeric material such that upon expanding the material desires to return to its unexpanded state and thereby pressurizes the fluid within the bladder 22.

Other embodiments of the pump 10 are also contemplated. In certain embodiments, the shell 13 is non-rigid and can deform to the shape of the bladder 22 when the bladder is inflated with the fluid. In a further example embodiment, the shell 13 can include a single end cap 14, 16 with the single cap having both an inlet port 20 and outlet port 18. As in the earlier example embodiment, the inlet port includes a stem 21 and filter 19 to allow sterile filtration of the fluid being injected into the bladder 22 and when the desired amount of fluid is input into the bladder 22, the portion of the stem 21 disposed between the filter 19 and the port 20 can be sealed and cut in a manner identical to the previous embodiments such that the filter 19 can be removed and integrity tested. In further embodiments, the bladder 22 can be of a material that does not possess a great degree of elasticity but the pump 10 includes a mechanism (not shown) that applies a force against the exterior of the bladder 22 upon the expansion of the bladder, thereby pressurizing the fluid within the bladder. For example within the shell can be a platen and biasing mechanism (not shown) whereby the expansion of the bladder 22 displaces the platen against the force of the biasing mechanism, thereby applying a counter force against the bladder.

While certain representative versions of the claimed subject matter have been described herein for purposes of illustrating the invention, it will be apparent to those skilled in the art that various changes in the devices and methods disclosed may be made without departing from the spirit and scope of the invention, which is defined by the following claims and is not limited in any manner by the foregoing description.

1. A sterile product bag comprising:
a bladder having a perimeter seal and defining a sterile chamber;
a stem extending through the perimeter seal and having an inlet end outside of the perimeter seal and an outlet end in fluid communication with the chamber;
a filter disposed in line with the stem, the filter having a filter membrane with a nominal pore size in a range of approximately 0.1 μm to approximately 0.5 μm, wherein the filter membrane is shaped as a hollow fiber with a wall and pores residing in the wall of the fiber; and
a vial adaptor and/or a Luer-Activated-Device (LAD) in selective fluid communication with the sterile chamber, wherein the filter membrane is disposed inside of the stem between the inlet and outlet ends.

2. (canceled)

3. (canceled)

4. The sterile product bag of claim 1, wherein the filter comprises a plurality of filter membranes

5. The sterile product bag of claim 1, wherein the outlet end of the hollow fiber of the filter membrane is sealed and the inlet end is an open inlet.

6.-8. (canceled)

9. The sterile product bag of claim 1, wherein the stem is one of a flexible stem or a rigid stem.

10.-12. (canceled)

13. The sterile product bag of claim 1, wherein the filter comprises a plurality of parallel hollow fiber membrane filters secured in a side-by-side configuration.

14. The sterile product bag of claim 1, wherein the filter comprises a plurality of parallel hollow fiber membrane filters arranged in a circular pattern.

15. The sterile product bag of claim 1, wherein the filter membrane has a nominal pore size in a range of approximately 0.1 μm to approximately 0.22 μm.

16. (canceled)

17. (canceled)

18. The sterile product bag of claim 1, wherein the chamber comprises at least a first chamber portion in fluid communication with the stem, and a second chamber portion isolated from the first chamber portion by an intermediate seal.

19. (canceled)

20. The sterile product bag of claim 18, wherein the bladder comprises adjacent front and rear films secured together by the perimeter seal, and the intermediate seal comprises a peelable seal formed by a bond between adjacent interior surface portions of the front and rear films, the peelable seal adapted to be broken to facilitate fluid communication between the first and second chamber portions.

21.-23. (canceled)

24. A sterile product bag comprising:
a bladder comprising adjacent front and rear films secured together by a perimeter seal and defining a sterile chamber comprising at least a first chamber portion and a second chamber portion isolated from the first chamber portion by a peelable seal formed by a bond between adjacent interior surface portions of the front and rear films,
the peelable seal adapted to be broken to facilitate fluid communication between the first and second chamber portions;
a stem extending through the perimeter seal and having an inlet end outside of the perimeter seal and an outlet end in fluid communication with the first chamber portion; and
a filter disposed in line with the stem, the filter having a filter membrane with a nominal pore size in a range of approximately 0.1 μm to approximately 0.5 μm, wherein the filter membrane is shaped as a hollow fiber with a wall and pores residing in the wall of the fiber, wherein the filter membrane is disposed inside of the stem between the inlet and outlet ends.

25.-43. (canceled)

44. A method of reconstituting a medicinal or nutritional substance, the method comprising:
providing a bladder having a perimeter seal and defining a sterile chamber, a stem extending through the perimeter seal and having an inlet end outside of the perimeter seal and an outlet end in fluid communication with the chamber, a filter disposed in line with the stem, the filter having a filter membrane with a nominal pore size in a range of approximately 0.1 μm to approximately 0.5 μm, wherein the filter membrane is shaped as a hollow fiber with a wall and pores residing in the wall of the fiber;
introducing a diluent into the chamber of the bladder through the filter membrane such that a sterile diluent resides within the chamber;
introducing a sterile medicinal or nutritional concentrate into the chamber of the bladder;
mixing the diluent and the concentrate in the chamber of the bladder to reconstitute the substance;
providing a vial adaptor including a sterile hollow cannula in fluid communication with the chamber of the bladder, a sheath disposed outside of the bladder and connected to the hollow cannula, the sheath comprising an interior cavity into which the hollow cannula extends, the peelable closure extending across an opening of the sheath to seal the interior cavity;
providing a vial containing the medicinal or nutritional concentrate and piercing a septum of the vial with the hollow cannula of the vial adaptor prior to introducing the concentrate to the chamber of the bladder; and
introducing a portion of the sterile diluent from the chamber of the bladder into the vial prior to introducing the concentrate to the chamber of the bladder.

45.-61. (canceled)

62. A method of reconstituting a medicinal or nutritional substance, the method comprising:
providing a bladder having a perimeter seal and defining a sterile chamber, a stem extending through the perimeter seal and having an inlet end outside of the perimeter seal and an outlet end in fluid communication with the chamber, a filter disposed in line with the stem, the filter having a filter membrane with a nominal pore size in a range of approximately 0.1 μm to approximately 0.5 μm, wherein the filter membrane is shaped as a hollow fiber with a wall and pores residing in the wall of the fiber;
introducing a diluent into the chamber of the bladder through the filter membrane such that a sterile diluent resides within the chamber;
introducing a sterile medicinal or nutritional concentrate into the chamber of the bladder; mixing the diluent and the concentrate in the chamber of the bladder to reconstitute the substance; and
sealing and cutting the stem at a location between the filter and the bladder after introducing the diluent through the filter.

63. The method of claim 62, further comprising performing a filter integrity test on the filter after cutting the stem and filter off of the product bag.

64. The method of claim 63, wherein performing the filter integrity test comprises one of a pressure degradation test, a bubble point test, a water intrusion test, or a water flow test.

65. A method preparing doses for patient delivery, the method comprising:
providing a bladder having a perimeter seal and defining a sterile chamber, a stem extending through the perimeter seal and having an inlet end outside of the perimeter seal and an outlet end in fluid communication with the chamber, a filter disposed in line with the stem, the filter having a filter membrane with a nominal pore size in a range of approximately 0.1 μm to approximately 0.5 μm, wherein the filter membrane is shaped as a hollow fiber with a wall and pores residing in the wall of the fiber;
introducing at least one medical fluid into the sterile chamber of the bladder through the filter membrane such that a sterile medical solution resides within the sterile chamber;
withdrawing a plurality of distinct and separate doses of the at least one sterile medical solution from the chamber through a Luer-Activated-Device (LAD) that is selectively fluidly coupled to the sterile chamber; and
sealing and cutting the stem at a location between the filter and the bladder after introducing the diluent through the filter.

66.-84. (canceled)

85. The method of claim 65, further comprising performing a filter integrity test on the filter after cutting the stem and filter off of the product bag.

86. The method of claim 65, wherein performing the filter integrity test comprises one of a pressure degradation test, a bubble point test, a water intrusion test, or a water flow test.

87.-99. (canceled)
